(19) United States
(12) Patent Application Publication
(10) Pub. No.: US 2025/0135800 A1
(43) Pub. Date: May 1, 2025

(54) TRANSFER FILM, COMPONENT, AND METHOD FOR THE PRODUCTION THEREOF

(71) Applicant: LEONHARD KURZ Stiftung & Co. KG, Fürth (DE)

(72) Inventors: Gert Jungmann, Fürth (DE); Harry Müller, Nürnberg (DE); Godknows Ibekwe, Waxhaw, NC (US)

(21) Appl. No.: 18/948,847

(22) Filed: Nov. 15, 2024

Related U.S. Application Data
(62) Division of application No. 17/769,440, filed on Apr. 15, 2022.

(30) Foreign Application Priority Data
Oct. 15, 2019 (DE) 102019127734.5

(51) Int. Cl. B44C 1/17; B29C 35/08; B29C 45/00; B29C 45/14; B29C 45/16; B32B 27/06; B32B 27/36; C09D 11/102; C09D 11/107; C09D 11/12; C09D 11/54; C09D 133/04

(52) U.S. Cl. CPC B44C 1/1712; B29C 45/14827; B29C 45/1657; B29C 45/1679; B32B 27/06; B32B 27/36; C09D 11/102; C09D 11/107; C09D 11/12; C09D 11/54; C09D 133/04; B29C 35/0805; B29C 35/0866; B29C 2045/0079; B29K 2995/002; B29K 2995/0026; B29K 2995/0072; B29K 2995/0097; B32B 2255/10; B32B 2255/26; B32B 2255/28; B32B 2307/748

(57) ABSTRACT

A transfer film (1), in particular for decorating casing components for motor vehicles or domestic appliances, including a carrier ply (3) with at least one carrier layer (31) and a transfer ply (2) arranged on the carrier ply (3), wherein the transfer ply (2) has a protective layer composite (21) including a first protective layer (5) and at least one receiving layer (4) for coating the transfer ply (2) in a coatable region (41) with at least one coating (6), wherein the at least one receiving layer (4) is arranged on the first protective layer (5) and wherein the at least one receiving layer (4) is arranged against a first surface of the transfer ply (2) facing towards the carrier ply (3). A method for producing a transfer film, as well as a component and a method for the production thereof using a transfer film.

### CROSS-REFERENCE TO RELATED APPLICATIONS

This application is divisional of U.S. patent application Ser. No. 17/769,440, filed Apr. 15, 2022, which is a national stage application based on International Application No. PCT/EP2020/078202, filed Oct. 8, 2020, which claims priority to DE 102019127734.5, filed Oct. 15, 2019.

### BACKGROUND OF THE INVENTION

The invention relates to a transfer film, a method for producing a transfer film, as well as a component and a method for the production thereof using a transfer film.

It is known to back-injection mold IMD transfer films (IMD=In-Mold Decoration) with a plastic material in an injection-molding tool. To guarantee the durability of products manufactured in such a way, the IMD transfer films often have protective layers which form an outside of the products after detachment of a carrier ply of the IMD transfer film. In order to guarantee a good durability, the protective layers have a low adhesion for foreign substances. As a result, however, the protective layers also have a low adhesion for materials applied to them, such as for example printing inks, with the result that the overprintability of the protective layers is poor. Printing inks are therefore arranged on the inside of the protective layers, thus the protected side.

Films with a higher adhesion for printing inks, on the other hand, are only known for short-lived goods, such as for example packaging, and do not have a protective varnish or have a poor durability.

### SUMMARY OF THE INVENTION

The object of the present invention is thus to provide a transfer film, a component and methods for the production thereof which make it possible to produce a component with good durability and, at the same time, overprintability by means of a cost-effective and simple method.

The object is achieved by providing a transfer film, in particular for decorating casing components for motor vehicles or domestic appliances, which comprises a carrier ply with at least one carrier layer and a transfer ply arranged on the carrier ply. The transfer film is characterized in that the transfer ply has a protective layer composite comprising a first protective layer and at least one receiving layer for coating the transfer ply in a coatable region with at least one coating, wherein the at least one receiving layer is arranged on the first protective layer and wherein the at least one receiving layer is arranged against a first surface of the transfer ply facing towards the carrier ply.

The object is further achieved by providing a method for producing a transfer film, wherein the following steps are carried out, in particular in the specified sequence: I) providing at least one carrier layer of a carrier ply; III) applying a transfer ply to the carrier ply, wherein the transfer ply has a protective layer composite comprising a first protective layer and at least one receiving layer for coating the transfer ply in a coatable region with at least one coating, wherein the at least one receiving layer is arranged on the first protective layer and wherein the at least one receiving layer is arranged against a first surface of the transfer ply facing towards the carrier ply.

The object is likewise achieved by providing a component, in particular a casing component for motor vehicles or domestic appliances, comprising a base body and at least one transfer ply arranged against at least one surface of the base body at least in regions, wherein the transfer ply has a protective layer composite comprising a first protective layer and at least one receiving layer, wherein the at least one receiving layer is arranged on the first protective layer in a coatable region and is arranged on a side of the transfer ply facing away from the base body.

The object is further achieved by providing a method for producing a component using a transfer film, wherein the method comprises the following steps, in particular in the specified sequence: a) providing a transfer film which comprises a carrier ply with at least one carrier layer and a transfer ply arranged on the carrier ply, wherein the transfer ply has a protective layer composite comprising a first protective layer and at least one receiving layer for coating the transfer ply in a coatable region with at least one coating, wherein the at least one receiving layer is arranged on the first protective layer and wherein the at least one receiving layer is arranged against a first surface of the transfer ply facing towards the carrier ply; b) joining a base body to at least one surface of the transfer ply facing away from the carrier ply; c) detaching the carrier ply from the transfer ply joined to the base body; d) applying at least one coating to a surface of the transfer ply opposite the base body, wherein the at least one coating is applied in a coated region which is arranged in the coatable region at least in regions or over the whole surface.

It is hereby achieved in particular that a protective effect of the component that can be achieved by the first protective layer is not negatively influenced by the at least one receiving layer and the at least one coating and the adhesion of the at least one coating in the component is massively improved. It is further achieved for example that the component advantageously has a good overprintability, in particular until shortly before the completion of the component to form an end product. It is further guaranteed that, despite the good overprintability, the component has a particularly good durability because the protective layer composite and in particular also the at least one coating take on a protective function. The at least one coating thus preferably takes on a double function as a protective layer and as a decoration or information carrier, whereby the individualizability of the component is advantageously improved. In particular, it is herewith possible to provide a standard variant with the transfer film, which can then be easily modified or adapted during the production of the film body by means of the at least one coating. It has surprisingly been shown in particular that it is possible for the surface of the component in the coatable region also to have a good durability in regions in which the at least one receiving layer has been applied, but the at least one coating has not been applied at least in regions. The coatability is thus improved, wherein the protective function is retained. Because of the overprintability and the protective function of the carrier ply of the transfer film and protective layer composite, a simple, flexible and reliable method is in particular also guaranteed during the production of the transfer film and the component.

The first protective layer, in particular in step III), advantageously starts to dissolve the at least one receiving layer at least partially, in particular in such a way that a mixed layer forms between the at least one receiving layer and the first protective layer or from the at least one receiving layer and the first protective layer. The at least one receiving layer and/or the mixed layer thus preferably forms a surface which is more easily dissolvable by means of the at least one coating, for example in the form of a UV printing ink and/or a UV ink. It is hereby possible for the adhesion to the at least one coating to be improved and in particular also for a durable composite to be producible.

Advantageous designs of the invention are specified in the dependent claims.

The transfer film is preferably an IMD transfer film. The transfer film is thus preferably used in an IMD method. The component is preferably produced in an IMD method. The method for producing the component is preferably an IMD method. The at least one coating in step d) is preferably applied to the at least one receiving layer at least in regions.

The component preferably has at least the at least one coating and in regions optionally also the first protective layer and/or also the at least one receiving layer as an outermost surface, in particular when the carrier ply is peeled off. Preferably, in particular after the carrier ply has been peeled off and the at least one coating has been applied, no further layers are applied to the at least one coating. In particular as no further protective layer is thus preferably also applied to the at least one coating and/or the protective layer composite, it is advantageous that a good durability of the outermost surface is guaranteed.

The coatable region of the transfer film and/or the component, in the case of an observation perpendicular to a plane spanned by the first protective layer and/or the at least one receiving layer, is preferably spanned by the at least one receiving layer and/or completely comprised by the first protective layer. The first protective layer preferably has the coatable region at least in regions or over the whole surface.

The coatable region preferably consists of one or more regions that are contiguous and/or separated from each other and/or in particular in the case of an observation perpendicular to a plane spanned by the at least one receiving layer is preferably patterned. Patterned preferably means having one or more patterns. A pattern is in particular a graphically designed outline, a figurative representation, an image, a symbol, a logo, an endless pattern, a portrait, an alphanumeric character, a text, a gridding and/or the like or a combination of one or more of the above patterns.

The coatable region is preferably coatable in particular at least in an intermediate step for producing a component having the protective layer composite, preferably in such a way that a reliable adhesion of the at least one coating is possible on and/or in the component in the coatable region.

Expediently, the at least one coating is applied in the coatable region at least in regions or over the whole surface. The coated region preferably overlaps the coatable region at least in regions or over the whole surface. It is further possible for the coated region to be patterned in particular with the at least one receiving layer, in particular in the case of an observation perpendicular to a plane spanned by the at least one receiving layer.

The protective layer composite, in particular the at least one receiving layer and/or the first protective layer, preferably of the transfer film and/or of the component, is preferably not yet completely cured at least in regions. Preferably, the at least one receiving layer and/or the first protective layer is precured chemically and/or by means of irradiation, preferably UV irradiation, at least in regions and/or is still completely curable by means of irradiation, preferably UV irradiation, at least in regions. For this purpose, the at least one receiving layer and/or the first protective layer has at least one UV-crosslinkable polymer. A UV-crosslinkable polymer within the meaning of the invention preferably has at least one, preferably two or more, ethylenically unsaturated double bond(s).

Preferably, no UV curing takes place in particular for producing the transfer film. In particular a UV curing takes place, preferably very late, only after the joining of the base body to the transfer ply in step b), preferably in an IMD process, and in particular after the application of the at least one coating to the transfer ply in step d). In particular a UV curing preferably does not take place during the method for producing the transfer film or during the application. In particular the UV ink, preferably of the digital printer, is partially cured, preferably by means of an irradiation from at least one UV LED.

The term “ethylenically unsaturated double bond” preferably means a mono-, di- or trisubstituted C═C double bond which is not incorporated in an aromatic electron system. An ethylenically unsaturated double bond is preferably not conjugated with other double bonds.

Further preferably, the first protective layer, preferably of the transfer film and/or of the component, is chemically cured and/or chemically precured and the first protective layer as well as the at least one receiving layer, preferably of the transfer film and/or of the component, is not yet completely cured and thus in particular is completely curable by means of UV irradiation. The at least one receiving layer, preferably of the transfer film, in the coatable region is preferably not yet completely cured at least in regions. The at least one coating of the component, in particular immediately after step d), is preferably not yet completely cured and is completely curable by means of UV irradiation.

It is also possible in particular that the protective layer composite, preferably the at least one receiving layer and/or the first protective layer, in the component is not yet completely cured at least in regions, in particular wherein the component is still protected by means of the carrier ply of the transfer film. The carrier layer comprises or preferably consists of PET.

The component preferably comprises at least one transfer film which is arranged against at least one surface of the base body at least in regions and which in particular has the carrier ply and the transfer ply, in particular wherein the at least one coating and/or the protective layer composite is not yet completely cured and/or is at least partially curable. Further preferably, the component preferably represents an intermediate product which is advantageously still further coatable, for example overprintable, and is thus preferably individualizable, as soon as the carrier ply has been or is detached.

It is further possible for the carrier ply of the transfer film preferably to be detached and/or not present in the component, in particular wherein the at least one coating is applied to the at least one receiving layer in an immediately following step or has been applied immediately beforehand.

“Not yet completely cured” preferably describes a layer, in particular the first protective layer, the at least one receiving layer and/or the at least one coating, when the hardness and/or durability thereof does not yet have a fixed minimum value. The fixed minimum value of the hardness and/or the durability is preferably a function of the ultimate intended use of the layer, e.g. as a protective layer and/or as an intermediate layer for forming an optical effect. “Completely cured” within the meaning of the present invention therefore describes a layer when the polymerization and/or crosslinking and/or hardness and/or durability thereof has a fixed minimum value.

It is possible for the above-named minimum values to be fixed such that a layer is described as “not yet completely cured” within the meaning of the present invention when not more than 95% of the polymer constituents of the layer that are capable of crosslinking have a crosslinking. A layer is therefore preferably described as “completely cured” within the meaning of the present invention when more than 95% of the polymer constituents of the layer that are capable of crosslinking have a crosslinking. A completely cured layer is present in particular when a complete (>95%) crosslinking of its polymer constituents has been effected. Further, it is possible in particular for a layer which is not yet completely cured still to be able to dry physically. It is thus also possible in particular that a precuring and/or curing can be carried out by means of physical drying and/or that a not yet completely cured layer can preferably be physically drying.

Expediently, the at least one receiving layer, preferably at least in the coatable region, has at least one water-dispersible polymer, which is selected in each case independently of one another from the group which consists of polyurethanes, polyacrylates, polymethacrylates, polyesters, copolymers thereof and mixtures thereof, preferably selected from polyurethanes, polyurethane/polyacrylate copolymers, polyacrylates and/or polymethacrylates, polyesters and mixtures thereof, wherein the at least one water-dispersible polymer is preferably a polyurethane-containing polymer, which is preferably selected from the group which consists of polyurethanes, polyurethane/poly(meth)acrylate copolymers and mixtures thereof.

The first protective layer is preferably produced on the basis of at least one UV-crosslinkable and/or chemically crosslinkable polymer.

It is further possible for the first protective layer furthermore to have at least one chemically crosslinkable polymer, which is further preferably selected from the group which consists of isocyanate-group-containing polymers, melamine-containing polymers, hydroxyl-group-containing polymers and mixtures thereof.

The first protective layer preferably has at least one chemically crosslinkable polymer combination, which comprises or is a polymer and/or copolymer with at least one, preferably two or more, isocyanate group(s) and at least one polymer and/or copolymer with at least one, preferably two or more, hydroxyl group(s) and/or at least one melamine resin and at least one polymer and/or copolymer with at least one, preferably two or more, hydroxyl group(s).

It is further possible for the at least one UV-crosslinkable polymer of the first protective layer and/or the at least one receiving layer furthermore to have, in each case independently of one another, at least one chemically crosslinkable functional group, wherein the chemically crosslinkable functional group is preferably selected from hydroxyl group, isocyanate group, melamine group, epoxide group and combinations thereof.

Preferably, the at least one UV-crosslinkable polymer furthermore has at least one hydroxyl group.

Suitable UV-crosslinkable hydroxyl-group-containing polymers are known from the state of the art and comprise for example at least one diacrylate monomer, aliphatic polyether urethane diacrylate, aliphatic polyester urethane diacrylate, aromatic polyether urethane diacrylate, aromatic polyester urethane diacrylate, polyester diacrylate, polyether diacrylate, epoxy diacrylate, acrylated acrylic diacrylate, polyacrylate monomer, aliphatic polyether urethane polyacrylate, aliphatic polyester urethane polyacrylate, aromatic polyether urethane polyacrylate, aromatic polyester urethane polyacrylate, polyester polyacrylate, polyether polyacrylate, epoxy polyacrylate, acrylated acrylic polyacrylate or mixtures thereof and/or at least one hydroxy monoacrylate, hydroxy diacrylate, hydroxy polyacrylate, hydroxy-functionalized aliphatic polyether urethane monoacrylate, hydroxy-functionalized aliphatic polyester urethane monoacrylate, hydroxy-functionalized aromatic polyether urethane monoacrylate, hydroxy-functionalized aromatic polyester urethane monoacrylate, hydroxy-functionalized polyester monoacrylate, hydroxy-functionalized polyether monoacrylate, hydroxy-functionalized epoxy monoacrylate, hydroxy-functionalized acrylated acrylic monoacrylate, hydroxy-functionalized aliphatic polyether urethane diacrylate, hydroxy-functionalized aliphatic polyester urethane diacrylate, hydroxy-functionalized aromatic polyether urethane diacrylate, hydroxy-functionalized aromatic polyester urethane diacrylate, hydroxy-functionalized polyester diacrylate, hydroxy-functionalized polyether diacrylate, hydroxy-functionalized epoxy diacrylate, hydroxy-functionalized acrylated acrylic diacrylate, hydroxy-functionalized aliphatic polyether urethane polyacrylate, hydroxy-functionalized aliphatic polyester urethane polyacrylate, hydroxy-functionalized aromatic polyether urethane polyacrylate, hydroxy-functionalized aromatic polyester urethane polyacrylate, hydroxy-functionalized polyester polyacrylate, hydroxy-functionalized polyether polyacrylate, hydroxy-functionalized epoxy polyacrylate, hydroxy-functionalized acrylated acrylate or mixtures thereof.

As melamine resins, in particular, those which can be obtained by reacting melamine with aldehydes and optionally can be partially or completely modified are suitable.

In particular, formaldehyde, acetaldehyde, isobutyraldehyde and glyoxal are suitable as aldehydes.

Melamine formaldehyde resins are preferably reaction products of the reaction of melamine with aldehydes, for example the above-named aldehydes, in particular formaldehyde. The methylol groups obtained are preferably modified by etherification with mono- or polyhydric alcohols.

Further, it is possible for the first protective layer to have precured systems and/or hybrid systems. It is possible in particular for the first protective layer to have at least one UV-curable component consisting of UV-curable monomers and/or UV-curable oligomers or mixtures thereof and furthermore to have at least one binder, which is selected from the group which consists of polyurethanes, polyacrylates, polymethacrylates, polyester resins, polycarbonates, phenolic resins, epoxy resins, polyureas, melamine resins, preferably polymethyl methacrylate (PMMA), polyester, polycarbonate (PC) and mixtures thereof.

It is further possible for the first protective layer preferably to comprise at least one polyisocyanate. The term “polyisocyanate” preferably describes an organic compound with two or more isocyanate groups, including triisocyanates and higher-functional isocyanates. In particular embodiments, the at least one polyisocyanate is selected from the group which consists of diisocyanate monomer, diisocyanate oligomer, diisocyanate-terminated prepolymer, diisocyanate-terminated polymer, polyisocyanate monomer, polyisocyanate oligomer, polyisocyanate-terminated prepolymer, polyisocyanate-terminated polymer, polyisocyanate-terminated polymer and mixtures thereof.

Further preferably, the at least one polyisocyanate comprises or is at least one diisocyanate-containing component, which preferably contains at least one diisocyanate-containing polyurethane oligomer, diisocyanate-containing polyurea oligomer, prepolymers thereof, polymer thereof or mixtures thereof.

In particular embodiments, the at least one polyisocyanate comprises or is at least one diisocyanate-containing component, which is preferably selected from the group which consists of hexamethylene diisocyanate (HDI), isophorone diisocyanate (IPDI), methylene diphenyl diisocyanate (MDI), toluene diisocyanate (TDI), phenylene diisocyanate, naphthalene diisocyanate, diphenyl sulfone diisocyanate, ethylene diisocyanate, propylene diisocyanate, dimers of these diisocyanates, trimers of these diisocyanates, triphenylmethane triisocyanate, polyphenylmethane polyisocyanate (polymeric MDI) and mixtures thereof.

In step d) the at least one coating is preferably applied in the form of one or more printed layers, in particular by means of digital printing, preferably by means of inkjet printing and/or pad printing and/or screen printing. It is possible in particular for one or more printed layers, preferably of the component and/or at least in the application of the at least one coating in step d), in each case independently of one another, to comprise or consist of an inkjet printing ink and/or a pad printing ink and/or a screen printing ink and/or to comprise or consist of a UV printing ink, a UV ink, a solvent printing ink and/or an aqueous printing ink.

A UV printing ink and/or a UV ink is in particular one curable by means of UV irradiation and preferably comprises corresponding photoinitiators. In particular, through the possibility of a curing by means of UV irradiation of the at least one coating, in particular of one or more printed layers, the advantage is achieved that they preferably form a particularly good adhesion to the at least one receiving layer after complete curing.

In particular, one or more layers of the one or more printed layers, preferably of the component and/or in the method for producing the component, preferably at least in the application of the at least one coating in step d), comprise at least one UV printing ink and/or at least one UV ink, which preferably comprises or consists of monomers, in particular with at least one ethylenically unsaturated double bond, or oligomers, in particular with at least one ethylenically unsaturated double bond, or mixtures thereof.

Further, it is possible, in particular in the method for producing the component, preferably at least in the application of the at least one coating in step d), for the at least one UV printing ink and/or the at least one UV ink to comprise the following constituents and/or for the at least one UV printing ink and/or the at least one UV ink of the component to be produced by means of the following constituents:
2-(2-vinyloxyethoxy)ethyl acrylate, in particular with a concentration in a range of from at least 50 wt.-% to less than 100 wt.-% (wt.-%=percent by weight);
oxybis(methyl-2,1-ethanediyl) diacrylate, in particular with a concentration in a range of from at least 10 wt.-% to less than 20 wt.-%;
diphenyl(2,4,6-trimethylbenzoyl)phosphine oxide, in particular with a concentration in a range of from at least 3 wt.-% to less than 5 wt.-%;
phenylbis(2,4,6-trimethylbenzoyl)phosphine oxide, in particular with a concentration in a range of from at least 1 wt.-% to less than 5 wt.-%;
2,6-bis(1,1-dimethylethyl)-4-methylphenol, in particular with a concentration in a range of from at least 0.1 wt.-% to less than 0.25 wt.-%, in each case relative to the total weight of the at least one UV printing ink and/or the at least one UV ink.

UV printing inks are preferably used for the pad printing and/or screen printing. UV inks are preferably used for inkjet printing. In particular, it is possible for the viscosity, preferably the dynamic viscosity, of UV printing inks to be higher than the viscosity, preferably the dynamic viscosity, of UV inks.

The at least one coating for the tests below preferably comprises a printed layer with the above composition of a UV printing ink and/or UV ink and/or is produced with such a composition and is in particular completely cured.

In particular for the method for producing the transfer film, preferably in step III), the following properties and compositions are preferably advantageous.

The application of the receiving layer in the method for producing the transfer film in step III) preferably comprises the following step:
IIIa) applying at least one, preferably flowable, first coating composition to at least partial regions of a surface of a first side of the carrier ply, wherein the at least one first coating composition has at least one solvent and at least one water-dispersible polymer, which is selected from the group which consists of polyurethanes, polyacrylates, polymethacrylates, polyesters, copolymers thereof and mixtures thereof. Further, step IIIa) comprises in particular an at least partial curing of the at least one first coating composition, to obtain at least one receiving layer.

The at least partial curing in step IIIa) is preferably a physical drying.

The first coating composition preferably comprises at least one water-dispersible polymer, which is selected from the group which consists of aqueous polyurethane dispersions, aqueous dispersion of polyurethane/polyacrylate copolymers, aqueous polyacrylate and/or polymethacrylate dispersions, aqueous polyester dispersions and mixtures thereof. It is further possible for the first coating composition to comprise at least one polyurethane-containing polymer, which is preferably selected from the group which consists of polyurethanes, polyurethane/poly(meth)acrylate copolymers and mixtures thereof.

The first coating composition preferably comprises at least one solvent, which consists of water, organic solvents, preferably aliphatic alcohol, such as for example ethanol, isopropanol, butanol or mixtures thereof.

The dynamic viscosity of the first coating composition preferably has been or is chosen depending on the printing method, for example in the case of a gravure printing method depending on the speed and gridding of the gravure printing cylinder. The first coating composition preferably has a dynamic viscosity in a range of from 10 mPas to 1000 mPas, preferably in a range of from 50 mPas to 500 mPas, in particular measured in a state immediately before step IIIa).

For example, water has a dynamic viscosity of 1 mPas. A very thin first coating composition preferably has a dynamic viscosity of 50 mPas. A thick first coating composition has in particular a dynamic viscosity of 500 mPas.

It is further expedient that the application of the first protective layer in step III) comprises the following step:
IIIb) applying at least one, preferably flowable, second coating composition to at least partial regions of a surface of the side of the at least one receiving layer facing away from the carrier ply, wherein the at least one second coating composition comprises at least one UV-crosslinkable and/or chemically crosslinkable polymer. Further, step IIIb) comprises in particular an at least partial curing of the at least one second coating composition, to obtain at least one first protective layer.

The at least partial curing in step IIIb) is preferably a physical drying. It is in particular conceivable that the first protective layer starts to dissolve the at least one receiving layer before the partial curing, as a result of which the mixed layer preferably forms. In particular, at least the mixed layer is preferably at least partially cured by physical drying.

It is expedient that the at least one second coating composition has at least one UV-crosslinkable polymer and preferably furthermore at least one chemically crosslinkable polymer, which is further preferably selected from the group which consists of isocyanate-group-containing polymers, melamine-containing polymers, hydroxyl-group-containing polymers and mixtures thereof. It is possible here for the at least one second coating composition to have at least one polymer and/or copolymer with at least one isocyanate group and at least one polymer and/or copolymer with at least one hydroxyl group

and/or at least one melamine resin and at least one polymer and/or copolymer with at least one hydroxyl group. In particular, a chemical crosslinking is herewith provided by the reaction of isocyanate groups with hydroxyl groups and/or achieved through the reaction of melamine resins with hydroxyl groups.

In particular, the at least one UV-crosslinkable polymer furthermore has at least one chemically crosslinkable functional group, which is preferably selected in each case independently of one another from hydroxyl group, isocyanate group, melamine group, epoxide group.

It is also possible for the at least one UV-crosslinkable polymer to have at least one hydroxyl group.

With respect to suitable hydroxyl-group-containing polymers, melamine resins, aldehydes, melamine formaldehyde resins, precured and/or hybrid systems as well as polyisocyanates, reference is made in particular to the above-named statements.

The at least one receiving layer preferably has one or more of the following constituents, in particular with a concentration in percent by weight, preferably based on a liquid state of the at least one receiving layer, in the range specified in each case:

| Constituent | Concentration in percent by weight |
|---|---|
| Deionized water | 25-35 |
| Isopropanol | 55-65 |
| Aqueous polyurethane dispersion | 5-15 |
| Cellulose derivative | 5-10 |
| Carnauba wax dispersion | 10-15 |
| Additives | 1-3 |
| Ammonia 25%, in particular a 25% | 0.1-0.5 |
| ammonia solution, preferably in | |
| water and/or isopropanol | |

By the liquid state of the at least one receiving layer is meant in particular that solvents have not yet leaked out of the at least one receiving layer. In particular, it also means a state of the at least one receiving layer immediately before or after the application of the at least one receiving layer to the carrier ply in step III). The at least one receiving layer for the tests below preferably comprises the constituents of the above composition and/or is produced with such a composition and is in particular completely cured.

The first protective layer, in particular in the form of a protective varnish layer, preferably has one or more of the following constituents, in particular with a concentration in percent by weight, preferably based on a liquid state of the first protective layer, in the range specified in each case:

| | Concentration in |
|---|---|
| Constituent | percent by weight |
| Melamine formaldehyde resin | 0.1-1.5 |
| Catalyst | 0.1-1.5 |
| Ethanol | 15-20 |
| Diacetone alcohol | 15-20 |
| 60% solution of a hydroxyl-containing | 20-30 |
| polyacrylic acrylate in an organic solvent | |
| Polyacrylic acrylate | 4-6 |
| Amorphous silica | 2-5 |
| Cyclohexanone | 10-20 |
| Methyl ethyl ketone | 10-12 |
| Photoinitiator | 0.1-1 |

By the liquid state of the first protective layer is meant in particular that solvents have not yet leaked out of the first protective layer. In particular, it also means a state of the first protective layer immediately before or after the application of the first protective layer to the at least one receiving layer and/or the carrier ply in step III). The first protective layer for the tests below preferably comprises the constituents of the above composition and/or is produced with such a composition and is in particular completely cured.

The first protective layer and/or the second coating composition preferably is or comprises a dual-cure system, preferably for example based on a hydroxyl-containing polyacrylic acrylate crosslinked with melamine resin.

A dual-cure system can in particular be cured in two curing steps, which is based on a combination of a chemical crosslinking and a curing of UV-crosslinkable polymers.

It is possible in particular for the at least one receiving layer to be a physically drying system or to have been or to be produced therewith, in particular to be a merely physically drying system or to have been or to be produced therewith, and/or for the first protective layer to be a system that dries physically and can be crosslinked chemically and/or by means of UV irradiation or to have been or to be produced therewith. In particular, the first and second coating composition is in each case an at least physically drying system or is based thereon. The at least one receiving layer and/or the first coating composition is in particular a physically drying system which is preferably formulated from thermoplastics. In particular, the curing of the first coating composition and/or the at least one receiving layer is effected by means of physical drying, preferably merely by means of physical drying, thus preferably merely by release, in particular by evaporation, of solvents contained in the first coating composition and/or the at least one receiving layer.

The first protective layer and/or the second coating composition is preferably also chemically crosslinkable preferably in the transfer film and/or in the component and/or is preferably chemically crosslinked in the method for producing the component.

It is possible in particular for the first protective layer and/or the second coating composition to differ from the at least one receiving layer and/or the first coating composition in that the first protective layer and/or the second coating composition is chemically crosslinkable and/or is curable by means of UV radiation.

The first protective layer preferably differs from the at least one receiving layer in particular in that the first protective layer at least one chemically crosslinkable polymer, in particular consists of isocyanate-group-containing polymers or melamine-containing polymers or hydroxyl-group-containing polymers or mixtures thereof, wherein the at least one receiving layer is based on a thermoplastic polymer and/or a thermoplastic resin.

Preferably, it is thus possible that in particular the at least one receiving layer and/or the first coating composition, in particular in the method for producing the transfer film and/or the component, preferably is not chemically crosslinkable or crosslinked and/or is not crosslinkable or crosslinked by means of UV radiation.

In step III), in particular in step IIIa), the at least one receiving layer is preferably applied to the carrier ply in the coatable region. Further, in step III), in particular in step IIIb), the first protective layer is preferably applied to the at least one receiving layer at least in the coatable region and to the carrier ply optionally outside the coatable region.

Preferably, the first protective layer in step III), preferably in step IIIb), and/or the at least one receiving layer in step III), preferably in step IIIa), is applied to the carrier ply and/or joined to the carrier ply by means of printing, in particular by means of gravure printing and/or flexographic printing and/or screen printing and/or inkjet printing.

The method for producing the component expediently further comprises the following step, which is carried out after step d), and in particular before or after step e):
f) completely curing the protective layer composite, in particular the at least one receiving layer and/or the first protective layer, and/or the at least one coating.

In step f) all curable constituents of the component, in particular the protective layer composite and the at least one coating, are preferably completely cured.

It is also conceivable that the curing of the first protective layer is effected by means of UV irradiation at least partially in a varnishing machine and/or printing device, in particular after the application of the at least one coating in step d).

It is also possible for the curing to be effected in several sub-steps, for example for a precuring and/or a complete curing of the UV printing ink and/or the UV ink to be carried out in the varnishing machine and/or the printing device, wherein it is possible for the protective layer composite to be cured as well at least in regions. Further, it is possible for a complete curing of the entire component then to be carried out, in particular by irradiating the component or at least all UV-curable regions of the component with UV irradiation over the whole surface.

In particular, in step f) the complete curing of the protective layer composite, in particular the at least one receiving layer and/or the first protective layer, and/or the at least one coating is carried out by means of high-energy electromagnetic radiation, in particular UV irradiation, and/or by means of high-energy particle radiation, in particular electron beam radiation, and/or by means of curing, preferably at a temperature in a range of from 25° C. to 180° C., of the at least one receiving layer, the first protective layer and/or the at least one coating.

The irradiation is preferably carried out by means of high-energy electromagnetic radiation and/or high-energy particle radiation. The electromagnetic radiation is preferably UV radiation, in particular from a wavelength range of from 100 nm to 390 nm, preferably 200 nm to 380 nm, particularly preferably 200 nm to 300 nm. The particle radiation is preferably electron beam radiation. For the complete curing in step f) one or more irradiation units are preferably used, which are preferably arranged behind the printing device. Step f) is carried out correspondingly in particular after step d).

For the complete curing in step f) the component, in particular the at least one coating and/or the protective layer composite, preferably the first protective layer and/or the at least one receiving layer, is irradiated with an irradiance in a range of from 500 mW/cm² to 700 mW/cm². The UV dose preferably lies in a range of from 2000 mJ/cm² to 3500 mJ/cm².

Due to the possibility of carrying out step f) and/or the not yet completely cured protective layer composite, in particular the not yet completely cured at least one receiving layer and/or first protective layer, and/or the not yet completely cured at least one coating a range of advantages result. The transfer film and/or the component is hereby in particular more easily deformable than a transfer film or a component with completely cured layers. In the case of the generation of curvatures it is thereby also guaranteed in particular that corresponding layers can stretch without the occurrence of cracking and other adverse effects. If a deformation in particular of the transfer film, for example in an injection mold or during a deep drawing, has been effected, the protective layer composite, in particular the at least one receiving layer and/or first protective layer, and/or also the at least one coating can be post-cured in order to achieve its ultimate hardness and durability.

Further, a mutual at least partial penetration of the first protective layer, the at least one receiving layer and/or the at least one coating, in particular before the preferably complete curing, is advantageously made possible, which preferably makes the particularly good adhesion and durability in the cured state possible. After a curing in step f) it is made possible in particular for the component produced to achieve the advantageous test results named below.

The first protective layer preferably has a layer thickness in a range of from 1 μm to 15 μm, preferably in a range of from 2 μm to 8 μm, preferably in a range of from 2 μm to 5 μm. The at least one receiving layer advantageously has a layer thickness in a range of from 0.01 μm to 1 μm, preferably in a range of from 0.05 μm to 0.5 μm. With such a relatively small layer thickness of the at least one receiving layer, it is possible for example for in particular a necessary durability of the protective layer composite by means of the first protective layer to be retained and for the coatability of the protective layer composite to be improved in the process.

The at least one coating preferably is or has been applied in the form of a pattern. The at least one coating preferably comprises one or more of the following layers: one or more printed layers, one or more further transfer plies and/or one or more further transfer films.

It is further possible for at least one of the one or more further protective layers and/or the first protective layer to be a protective varnish layer.

The transfer ply is preferably detachable from the carrier ply. It is possible for the carrier ply to have at least one detachment layer, which is arranged between the carrier layer and the protective layer composite. The layer thickness of the detachment layer lies in particular in a range of from 0.1 nm to 100 nm. The detachment layer preferably comprises or consists of at least one wax, for example a polyethylene wax. The detachment layer preferably has a melting temperature in a range of from 80° C. to 100° C. The transfer ply, in particular the at least one receiving layer, preferably has been or is arranged at least in regions on the side of the detachment layer which faces away from the at least one carrier layer. The carrier ply is preferably arranged on the protective layer composite, in particular the at least one receiving layer and/or the first protective layer, with an adhesive force in a range of from 2 cN to 50 cN, preferably in a range of from 5 cN to 35 cN.

The method expediently has the following step, in particular before step II):
II) applying a detachment layer to the carrier layer of the carrier ply in such a way that the detachment layer preferably forms a surface of the carrier ply to which the protective layer composite is applied at least in regions in step III). The application of the detachment layer to the carrier layer of the carrier ply in step II) is preferably carried out by means of gravure printing and/or flexographic printing and/or inkjet printing.

The transfer ply has in particular one or more decorative layers containing at least one decorative element, preferably on the side of the protective layer composite facing away from the carrier ply.

Further, one or more decorative layers of the one or more decorative layers containing the at least one decorative element are preferably selected, preferably selected in each case independently of one another, from the group which consists of transparent and/or colored varnish layers, in particular comprising one or more dyes and/or pigments, replication layers with molded optically active surface structure, reflective layers, in particular opaque reflective layers, transparent reflective layers, metallic reflective layers or dielectric reflective layers, optically variable layers, optically active layers, interference multilayer systems, volume hologram layers, liquid-crystal layers, in particular cholesteric liquid-crystal layers, electrically conductive layers, antenna layers, electrode layers, magnetic layers, magnetic storage layers, barrier layers and combinations thereof.

Alternatively or additionally, it is possible for the transfer ply to have one or more functional layers containing at least one functional element on the side of the protective layer composite facing away from the carrier ply. It is possible here for one or more of the one or more functional layers to be arranged overlapping and/or neighboring one or more of the one or more decorative layers. It also possible for one or more of the one or more functional layers to be arranged between one or more of the one or more decorative layers or on a side of the one or more decorative layers facing towards and/or facing away from the protective layer composite.

A functional element is in particular selected from the group which consists of one or more electronic elements, in particular one or more conductive tracks, contact elements, LEDs, sensors, in particular touch sensors, temperature sensors, pressure sensors, antennas, in particular RFID elements, memories, processors, capacitors, resistors, microfluidic elements and combinations thereof.

The component preferably comprises one or more decorative layers containing at least one decorative element, in particular of the transfer ply of the transfer film, and/or one or more functional layers containing at least one functional element, in particular of the transfer ply of the transfer film. In particular in step a) the transfer ply preferably comprises, on its side facing towards the base body, one or more decorative layers containing at least one decorative element, preferably of the transfer ply of the transfer film, and/or one or more functional layers containing at least one functional element, in particular of the transfer ply of the transfer film.

Preferably, the at least one decorative element is arranged in one or more decorative layers and/or the at least one functional element is arranged in one or more functional layers, which comprise, in each case independently of one another, a UV-crosslinked varnish or a thermoplastically deformable layer and which are, in each case independently of one another, unpigmented or pigmented or dyed.

An adhesion-promoter layer is preferably arranged between the protective layer composite, in particular the first protective layer, and the at least one decorative element and/or the at least one functional element. It is possible here for the adhesion-promoter layer to comprise or consist of at least one acrylic resin. Further, it is possible for the adhesion-promoter layer preferably to have a layer thickness in a range of from 0.1 μm to 10 μm.

It is also conceivable that in particular the protective layer composite preferably has, at least partially, a decorative element and/or a functional element or for example none of these.

It is also possible for the transfer ply to have at least one varnish layer, preferably with a layer thickness in a range of from 0.5 μm to 10 μm, which forms a surface of the transfer ply facing away from the carrier ply. This varnish layer is preferably used for joining to the base body. The at least one varnish layer preferably comprises or consists of at least one adhesive, which is selected from the group which consists of physically curing adhesives, chemically curing adhesives, pressure-sensitive adhesives or mixtures thereof. Further, it is possible for the at least one varnish layer to be a primer layer and/or for a primer layer to be arranged in place of the at least one varnish layer and/or for a primer layer to be arranged on the side of the at least one varnish layer facing away from the protective layer composite, in particular wherein the primer layer comprises or consists of PVC copolymers and PMMA (PVC=polyvinyl chloride, PMMA=polymethyl methacrylate).

Further, it is expedient that the at least one receiving layer has a roughness Ra in a range of from 1 nm to 250 nm, preferably in the range of from 5 nm to 100 nm, in particular measured when the carrier ply has been detached from the transfer ply and/or the first protective layer and/or the at least one receiving layer is not yet completely cured. As a result of this, in particular, the adhesion of the at least one coating to the at least one receiving layer is improved and the durability of the protective layer composite with the at least one coating is improved.

In particular in the case of a completely cured first protective layer, at least one receiving layer and/or at least one coating, the test results described in the following are preferably achieved.

The tests described below are preferably carried out in a test region of the component. The test region preferably comprises a surface of the component facing away from the base body, at least in the coatable region, in particular with the coated region with the at least one coating and preferably with the coatable region outside the coated region. Further, it is possible for the test region preferably also to have a surface of the first protective layer.

It is also possible for a test region to comprise a surface of at least the coatable region of the transfer ply of the transfer film on the side of the at least one receiving layer with a test coating, wherein to carry out the tests the transfer film is applied to a base, the carrier ply is peeled off the transfer ply, a test coating is applied to the at least one receiving layer in the test region, wherein the test coating is designed corresponding to the at least one coating of the component, and the test coating and the protective layer composite are completely cured.

It has surprisingly been shown that no surface changes are detected in the test region during a detergent test.

During the detergent test, preferably at a temperature of 70° C., the surface in the test region is brought into contact with a detergent, preferably brought into contact for 5 hours. The detergent is in particular a 1% detergent solution, in this example preferably with Persil®.

In particular, no surface change is detectable here on the at least one coating or the at least one receiving layer or the first protective layer. In particular in the case of a surface having only the first protective layer without the at least one receiving layer and/or only a conventional protective layer instead of the protective layer composite, no surface changes are likewise determined during such a detergent test. In particular, a chemical resistance is thus achieved which meets the requirements for protective layers in the usual use of a component preferably produced in an IMD method.

For example, it has further been shown that no change in the first protective layer with the at least one receiving layer is detected in the test region during an abrasion test according to ASTM D4060, preferably with a Taber Abraser, preferably after at least 300 cycles. The abrasion test is carried out in particular with an abrasive medium of the CS-10 Calibrase type and/or a load of 1000 g. Here, two abrasive media of the same type are preferably used, which are preferably rolled on the surface of the test region in each cycle. The load is in particular a load which determines a force acting on the surface in the test region in each case by the two abrasive media and results from the mass of the abrasive medium, of the load arm and where appropriate the mass of additional weights. In this case, a total weight of 1000 g per abrasive medium results.

During the abrasion test according to ASTM D4060, the surface to be tested is preferably checked for changes every 50 cycles and the number of cycles until an error pattern is determined. By an error pattern is meant here in particular that any changes in the surface are discernible. An error pattern in particular only occurs when at least 300 cycles are passed through.

In particular, an abrasion resistance is thus achieved which meets the requirements for protective layers in the usual use of a component in particular produced in an IMD method.

It has further been shown that the resistance to scratching is preferably improved by the at least one receiving layer and in particular the at least one coating applied thereto. This can be tested in particular by means of a test, in particular a scratch hardness test, with a test rod/tester, in particular from Erichsen, preferably of the Model 318 type. A test tip of the test rod is preferably dragged over the surface of the test region.

The test tip preferably presses on the surface of the test region with a force of 10 N. The test tip preferably has a diameter of 0.75 mm, in particular on a circular surface, which generates the force onto the at least one coating. The test tip is preferably dragged over the test region at a speed of approximately 1.5 cm/s over a length of from approx. 1 cm to 10 cm, preferably 5 cm.

It has surprisingly been shown that no scratching is detected on the surface of the test region here, in particular the at least one coating on the protective layer composite and/or the at least one receiving layer in regions without the at least one coating.

It can hereby be shown in particular that the at least one coating adheres better to the receiving layer than to conventional layers.

The protective layer composite and in particular the at least one coating applied thereto thus make a particularly mechanically resistant surface possible.

It is also possible for the resistance to chemicals, in particular measured according to ASTM D4752, preferably with a Double Rub Solvent Cure Test, an optical change corresponding to a fastness level greater than or equal to 4 to be detected. The fastness level is preferably determined with reference to a grayscale according to ISO 105-A02. The resistance to chemicals is in particular measured on a surface of a test region at least in the coatable region, in particular with the coated region with the at least one coating, on a side of the component facing away from the base body. It is possible in particular for the test region also to comprise a surface of the first protective layer.

To measure the resistance to chemicals (DELL) according to ASTM D4752 Double Rub Solvent Cure Test, a cloth soaked with MEK is preferably rubbed back and forth by hand over the surface of the test region. The cloth is preferably rubbed back and forth 50 times, thus is preferably rubbed over the surface 100 times. The surface of the test region is then washed off with water or IPA. MEK here preferably stands for methyl ethyl ketone. IPA here stands in particular for isopropyl alcohol. The change in the color of the surface of the test region is preferably measured, in particular by means of the state before and the state after the cloth is and, respectively, has been rubbed over the surface. Then, in particular, the for determining the optical change greater than or equal to 4 is detected, in particular determined with reference to a grayscale according to ISO 105-A02. The grayscale is preferably used to assess the change in the color. Preferably there are nine pairs of gray, matte chips with different contrast levels on the grayscale. With reference to the color differences of the pairs of chips, in particular a fastness level of from 1 (=strong color change) to 5 (=no color change) can be determined, preferably with four half-steps for more exact evaluation. For the assessment, in particular an untreated surface, preferably in the state before the cloth is rubbed over the surface, is compared with a treated surface, preferably in the state after the cloth has been rubbed over the surface, and the color change is preferably assessed visually with the aid of the pairs of chips on the grayscales. The fastness level makes it possible in particular to draw a conclusion as to how durable or color fast a color sample is when it is exposed to preferably everyday stresses such as washing, light, water or also sweat. The protective layer composite and in particular the at least one coating applied thereto thus make in particular a particularly chemically resistant and color-fast surface of the component possible.

In particular, it has advantageously been shown that, during a test of the adhesive strength, the adhesive strength measured on the surface of the test region according to DIN EN ISO 2409:2013-06 lies in the range of from GT0 to GT1 and/or according to ASTM D 3359-09, preferably Test Method B, in the range of from 5B to 4B, preferably wherein the protective layer composite, in particular the first protective layer and/or the at least one receiving layer (4), and the at least one coating are completely cured. It is conceivable in particular that the at least one coating and the at least one receiving layer are preferably the layers between which the minimum adhesive force prevails and/or which detach from one another first during the test of the adhesive strength. Here, it is possible in particular for the test region to be comprised completely by the coated region. It is also possible here in particular for such adhesive strengths to be determined in a region of the coatable region outside the coated region and/or in a region with the first protective layer outside the coatable region.

The adhesive strength is determined in particular with a cross-cut test according to DIN EN ISO 2409: 2013-06, preferably according to the German version of DIN EN ISO 2409: 2013-0 (Beschichtungsstoffe—Gitterschnittprüfung [Paints and varnishes—Cross-cut test] with the issue date 2013 June). In particular, in each case 6 cuts are made vertically and 6 cuts are made horizontally and/or 6 cuts running parallel at an angle of 90° to 6 further cuts running parallel in the at least one coating, here preferably using a knife and preferably using a stencil. The cuts in particular also penetrate the at least one receiving layer and/or the protective layer composite, preferably with a depth up to an undercoat and/or are cut up to the base body. The cut width is in particular chosen depending on the layer thickness of the at least one coating and/or the layer thickness of the protective layer composite, in particular the receiving layer and/or the first protective layer.

In the case of a layer thickness of the at least one coating and/or the layer thickness of the protective layer composite, in particular the at least one receiving layer and/or the first protective layer, with a layer thickness of less than 60 μm, the distance between the cuts is preferably approximately 1 mm.

In particular in a top view of the protective layer composite with the at least one coating, the cuts are preferably introduced in a measurement area, preferably in the shape of a square, which completely comprises the surface of the test region. The measurement area preferably herewith comprises the at least one coating at least over part of the surface. A clear adhesive tape or an adhesive crepe tape, in particular with an adhesiveness in a range of from 6 N/25 mm to 10 N/25 mm, is preferably stuck to the surface in the test region. The clear adhesive tape or the adhesive crepe tape is in particular peeled off the surface, preferably at an angle of 60°, in a period of from 0.5 s to 1 s after sticking.

The evaluation is effected in particular by a visual assessment of the surface of the test region and classification into cross-cut characteristic values of from 0 (very good adhesive strength) to 5 (very poor adhesive strength), which are preferably abbreviated to GT 0 to GT 5.

Alternatively or additionally, it is possible to determine the adhesive strength according to ASTM D 3359-09, Test Method B.

The criteria for a classification of the corresponding characteristic values are preferably to be found in the table below, in particular wherein possible surfaces of the test region are shown schematically with FIG. 8A, FIG. 8B, FIG. 8C and FIG. 8D:

| | | ISO | ASTM |
|---|---|---|---|
| | Surface of | charac- | charac- |
| | the test | teristic | teristic |
| Description | region | value | value |
| The edges of the cuts are | — | GT 0 | 5B |
| completely smooth, no section of | | | |
| the coating has flaked. | | | |
| Small flakes of the coating have | FIG. 8a) | GT 1 | 4B |
| detached at the intersections of | | | |
| the grid lines; flaked area | | | |
| approximately 5% of the | | | |
| sections. | | | |
| The coating has flaked along the | FIG. 8b) | GT 2 | 3B |
| edges of the cuts and/or at the | | | |
| intersections of the grid lines; | | | |
| flaked area approximately 15% | | | |
| of the sections. | | | |
| The coating has flaked partially | FIG. 8c) | GT 3 | 2B |
| or completely in broad strips | | | |
| along the edges of the cuts | | | |
| and/or the coating has flaked | | | |
| completely or partially on | | | |
| individual sections; flaked area | | | |
| approximately 35% of the | | | |
| sections. | | | |
| The coating has flaked in broad | FIG. 8d) | GT 4 | 1B |
| strips along the edges of the | | | |
| cuts and/or completely or | | | |
| partially on individual sections; | | | |
| flaked area approximately 65% | | | |
| of the sections. | | | |
| Flaked area more than 65% of | — | GT 5 | 0B |
| the sections. | | | |

In a range of from GT 0 to GT 1 and/or from 5B to 4B thus preferably means that an area of at most 5% has flaked.

In particular in a case where no receiving layer is present, i.e. if only the first protective layer and the at least one coating are present and/or the at least one coating is applied directly to the first protective layer, for example the detachment of the at least one coating from the surface partially occurs in the test region after a cross-cut test according to DIN EN ISO 2409: 2013-06, in particular with a result of from GT 4 to GT 5, preferably wherein the at least one coating overlaps the test region over the whole surface.

During the tests it has surprisingly been shown that the adhesion between the protective layer composite and the at least one coating is improved by the at least one receiving layer with an unchanged durability of the protective layer composite compared with conventional protective layers. In particular, it has thus been shown that, even in regions without the at least one coating, the durability compared with conventional protective layers is unchanged and is even improved in the coated regions with the at least one coating. Surprisingly, in a coatable region possibly not coated by means of the at least one coating, the protective layer composite is thus preferably no less durable than a conventional coated or uncoated protective layer. The coatability of the protective layer composite is thus advantageously improved by means of the receiving layer, wherein the protective function of the protective layer composite compared with conventional protective layers is retained, in particular independently of the design of the region coated with the at least one coating. The transfer film, in particular the protective layer composite, preferably the at least one receiving layer and/or the first protective layer, is advantageously designed in such a way that the above adhesive strengths and resistances of the component can be achieved.

During the above tests the at least one coating is or has been applied preferably in the form of the at least one UV printing ink and/or the at least one UV ink and in particular completely cured with the at least one receiving layer and preferably the first protective layer, preferably by means of UV irradiation.

It is further possible for the joining of the base body to at least one surface of the transfer ply of the transfer film facing away from the carrier ply to be effected in step b) by adhesive bonding, hot stamping, lamination or combinations thereof on at least one surface of the base body which is selected from the group which of paper, plastic, wood, composite, glass, metal and combinations thereof. It is herewith possible for the base body of the component to be selected from the group which consists of paper, plastic, wood, composite, glass, metal and combinations thereof. It is also possible for the base body to comprise or consist of a plastic injection-molding material. The plastic injection-molding material preferably comprises or consists of thermoplastic, thermoset or a mixture thereof. The base body preferably comprises a plastic injection-molding material, in particular consisting of PMMA.

It is possible in particular for the following steps to be carried out, in particular in the specified sequence, for carrying out step b) for joining the base body to the transfer ply:
b1) arranging the transfer film in an injection mold;
b2) back-injection molding the transfer film arranged in the injection mold with a plastic injection-molding material, in particular wherein a joining of the plastic injection-molding material to the transfer ply takes place through the back-injection molding and/or the base body is formed by the plastic injection-molding material.

It is possible in particular for the component to be a rigid body. It is preferably possible for the surface of the component, in particular with the protective layer composite and the at least one coating, to be curved and/or bent. The injection mold expediently has the shape of the surface of the component 10 and/or predefines it.

During the joining of the base body to the transfer ply in step b), in particular in step b2), the base body with at least one surface of the transfer ply of the transfer film facing away from the carrier ply is preferably covered with the plastic injection-molding material at least in regions, wherein the transfer film is arranged in the injection mold and the injection mold is filled with at least the plastic injection-molding material. Further, it is possible for the injection mold to be formed by two mold halves, in particular which are opened before step b1) and are closed before step b2), preferably wherein the injection mold is formed.

It is further conceivable that the transfer film is pre-deformed and/or deep drawn before step b1). Here, in particular because of the above-named stretchability, it is advantageous for example if the protective layer composite, in particular the at least one receiving layer and/or the first protective layer, are not yet cured at least in regions.

It is further possible for the joining of the base body to the at least one transfer ply in step b) and the detachment of the carrier ply in step c) to be carried out with a spatial separation. There is thus preferably a spatial separation between the joining of the base body to the at least one transfer ply in step b) and the detachment of the carrier ply in step c). Here, it is possible for the component to be stored temporarily and/or transported. In particular at another production location, it is then possible to individualize the component by means of the application of the at least one coating.

The following step is expediently carried out after step b), and in particular before step c), after step c), and in particular before step d), and/or after step d):
e) removing the base body with the transfer ply from the injection mold.

It is possible in particular for the base body with the transfer ply to be placed in a printing device, in particular a digital printer, preferably an inkjet printer, for carrying out step d). It is possible here for the detachment of the carrier ply from the transfer ply joined to the base body to be carried out for example first in the printing device and/or to be carried out before, in particular immediately before, it is placed in the printing device. Further, it is possible for the carrier ply to be peeled off immediately after the joining of the transfer ply to the base body in step b) and/or before the removal of the base body with the transfer ply from the injection mold in step e). The carrier ply is thus preferably peeled off still in an injection-molding tool with the injection mold, in particular wherein the method is an IMD method.

A flexible and reliable method is hereby advantageously guaranteed, and the individualizability of the component is improved.

It is also possible that in step d) the application of one or more layers of the at least one coating in a first region to the at least one receiving layer is carried out and optionally the at least one coating is not applied in a second region of the protective layer composite.

A second transfer film with a second transfer ply is preferably applied to the protective layer composite at least in the first region and optionally in the second region, wherein the second transfer film is then peeled off the protective layer composite with the at least one coating, in particular in such a way that the second transfer ply remains on the at least one receiving layer at least in regions in the first region, and is preferably peeled off the at least one receiving layer in the second region, in particular together with at least one carrier layer of the second transfer film. The first region is preferably completely comprised by the coatable region.

It is possible in particular for the application of the at least one coating to be carried out preferably by means of cold stamping, wherein the at least one coating comprises in particular at least one UV printed layer, preferably consisting of the at least one UV printing ink and/or the at least one UV ink, and a further transfer ply applied thereto.

Further, it is conceivable that only partial regions of the first region are completely comprised by the coatable region, in particular wherein the at least one coating is also applied to the first protective layer at least in regions during the application to the at least one receiving layer, wherein the second transfer film is then peeled off the protective layer composite with the at least one coating, in such a way that the second transfer ply remains only in the partial regions of the first region which are comprised by the coatable region.

It is further possible for the at least one coating to be modified and/or structured before and/or during and/or after the application of the at least one coating in step d), preferably by placing particles in/on the at least one receiving layer after step c) and/or by using tool structures during the application in step d) and/or by subsequent lasering, overprinting and/or overstamping of the at least one coating.

It is advantageous in particular if the following steps are carried out in the following sequence: a), b), e), c), d), f).

In particular, a use of the component as a vehicle part, in particular vehicle interior trim and/or vehicle exterior trim, housing part and/or external part of in particular white goods and/or domestic appliances, and/or as a display window for electronic devices, is conceivable.

### BRIEF DESCRIPTION OF THE DRAWINGS

In the following, the invention is explained by way of example with reference to several embodiment examples utilizing the attached drawings. There are shown in:

FIGS. 1A, 1B, 2 and 3, schematically, a transfer film,

FIGS. 4, 5A, 5B and 5C, schematically, a component,

FIG. 6, schematically, a method for producing a transfer film,

FIG. 7, schematically, a method for producing a component,

FIGS. 8A, 8B, 8C and 8D, schematically, surfaces of a test region in a cross-cut test.

### DETAILED DESCRIPTION

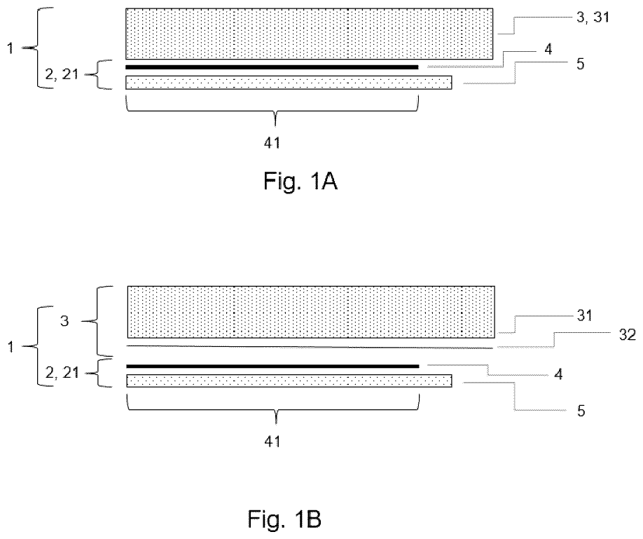

FIG. 1A schematically shows a cross section in an exploded drawing of a transfer film 1, in particular for decorating casing components for motor vehicles or domestic appliances. The transfer film 1 is preferably an IMD transfer film. The transfer film 1 comprises the carrier ply 3. The carrier ply 3 comprises at least one carrier layer 31. The carrier ply 3 is arranged on the transfer ply 2. The transfer ply 2 has the protective layer composite 21. The protective layer composite 21 comprises the first protective layer 5 and the at least one receiving layer 4. The at least one receiving layer 4 is provided with at least one coating for coating the transfer ply 2 in the coatable region 41. The at least one receiving layer 4 is in particular arranged on the first protective layer 5. The at least one receiving layer 4 is further arranged against a first surface of the transfer ply 2 facing towards the carrier ply 3. A surface of the transfer ply 2 with the at least one receiving layer 4 preferably directly adjoins a surface of the carrier ply 3.

The coatable region 41 is in particular spanned by the at least one receiving layer 4, preferably in the case of an observation perpendicular to a plane spanned by the at least one receiving layer 4. It is possible for the coatable region 41 to overlap the carrier ply 3 and/or the first protective layer 5 at least in regions or over the whole surface. In particular, the first protective layer 5 is applied to the at least one receiving layer 4 at least in the coatable region 41 and optionally to the carrier ply 3 outside and/or the at least one receiving layer 4 is applied to the carrier ply 3 in the coatable region 41.

The coatable region 41 preferably consists of one or more contiguous regions and/or is in particular patterned. It is also conceivable that the coatable region 41 consists of one or more regions that are separated from each other. The coatable region, in the case of an observation perpendicular to a plane spanned by the first protective layer 5 and/or the at least one receiving layer 4, is preferably completely comprised by the first protective layer 5.

The coatable region 41 is preferably coatable in particular at least in an intermediate step for producing a component having the protective layer composite 21, preferably in such a way that a reliable adhesion of the at least one coating in the coatable region is guaranteed. In particular, the transfer film 1 is thus preferably an intermediate product which is coatable and/or is coated by means of the at least one coating 6 in the further processing in the coatable region 41.

The carrier ply 3 and/or the at least one carrier layer 31 preferably comprises or consists of PET (=polyethylene terephthalate). The carrier ply 3 here has in particular a layer thickness of 50 μm. It is also possible for the carrier ply 3 to have a layer thickness in a range of from 1 μm to 100 μm.

It is possible for the first protective layer to be a protective varnish layer. Preferably, the first protective layer 5 in the transfer film 1 is not yet completely cured and/or is chemically crosslinkable and preferably precured by a physical drying in particular at least in regions. It is preferably possible for the first protective layer 5 to be completely curable by means of irradiation, in particular UV irradiation. The first protective layer 5 here is or comprises for example a dual-cure system, preferably based on a hydroxyl-containing polyacrylic acrylate crosslinked with melamine resin.

A dual-cure system can in particular be cured in two curing steps, which is based on a combination of a chemical crosslinking and a curing of UV-crosslinkable polymers. In particular a UV curing takes place, preferably very late, only after the joining of the base body to the transfer ply 2 in step b), preferably in an IMD process, and in particular after the application of the at least one coating 6 to the transfer ply 2 in step d). In particular a UV curing preferably does not take place during the method for producing the transfer film 1 or during the application. In particular the UV ink, preferably of the digital printer, is partially cured, preferably by means of an irradiation from at least one UV LED.

The at least one receiving layer 4 is in particular physically drying and/or precured or cured by a physical drying. The at least one receiving layer 4 is preferably not completely cured in the coatable region 41 at least in regions.

It is thus possible that the protective layer composite 21 is not yet completely cured at least in regions, in particular wherein the protective layer composite 21 is precured chemically and/or by means of irradiation, preferably UV irradiation, at least in regions and/or is completely curable by means of irradiation, preferably UV irradiation, at least in regions.

The first protective layer 5 preferably has at least one UV-crosslinkable polymer. A UV-crosslinkable polymer within the meaning of the invention preferably has at least one, preferably two or more, ethylenically unsaturated double bond(s).

It is further possible for the at least one receiving layer 4, preferably at least in the coatable region 41, to have at least one water-dispersible polymer, which is selected in each case independently of one another from the group which consists of polyurethanes, polyacrylates, polymethacrylates, polyesters, copolymers thereof and mixtures thereof, preferably selected from polyurethanes, polyurethane/polyacrylate copolymers, polyacrylates and/or polymethacrylates, polyesters and mixtures thereof, wherein the at least one water-dispersible polymer is preferably a polyurethane-containing polymer, which is preferably selected from the group which consists of polyurethanes, polyurethane/poly(meth)acrylate copolymers and mixtures thereof.

The first protective layer 5 is preferably produced on the basis of at least one UV-crosslinkable and/or chemically crosslinkable polymer.

It is further possible for the first protective layer 5 furthermore to have at least one chemically crosslinkable polymer, which is further preferably selected from the group which consists of isocyanate-group-containing polymers, melamine-containing polymers, hydroxyl-group-containing polymers and mixtures thereof.

The first protective layer 5 preferably has at least one chemically crosslinkable polymer combination, which comprises or is a polymer and/or copolymer with at least one, preferably two or more, isocyanate group(s) and at least one polymer and/or copolymer with at least one, preferably two or more, hydroxyl group(s) and/or at least one melamine resin and at least one polymer and/or copolymer with at least one, preferably two or more, hydroxyl group(s).

It is further possible for the at least one UV-crosslinkable polymer of the first protective layer 5 and/or the at least one receiving layer 4 furthermore to have, in each case independently of one another, at least one chemically crosslinkable functional group, wherein the chemically crosslinkable functional group is preferably selected from hydroxyl group, isocyanate group, melamine group, epoxide group and combinations thereof.

Preferably, the at least one UV-crosslinkable polymer furthermore has at least one hydroxyl group.

Suitable UV-crosslinkable hydroxyl-group-containing polymers are known from the state of the art and comprise for example at least one diacrylate monomer, aliphatic polyether urethane diacrylate, aliphatic polyester urethane diacrylate, aromatic polyether urethane diacrylate, aromatic polyester urethane diacrylate, polyester diacrylate, polyether diacrylate, epoxy diacrylate, acrylated acrylic diacrylate, polyacrylate monomer, aliphatic polyether urethane polyacrylate, aliphatic polyester urethane polyacrylate, aromatic polyether urethane polyacrylate, aromatic polyester urethane polyacrylate, polyester polyacrylate, polyether polyacrylate, epoxy polyacrylate, acrylated acrylic polyacrylate or mixtures thereof and/or at least one hydroxy monoacrylate, hydroxy diacrylate, hydroxy polyacrylate, hydroxy-functionalized aliphatic polyether urethane monoacrylate, hydroxy-functionalized aliphatic polyester urethane monoacrylate, hydroxy-functionalized aromatic polyether urethane monoacrylate, hydroxy-functionalized aromatic polyester urethane monoacrylate, hydroxy-functionalized polyester monoacrylate, hydroxy-functionalized polyether monoacrylate, hydroxy-functionalized epoxy monoacrylate, hydroxy-functionalized acrylated acrylic monoacrylate, hydroxy-functionalized aliphatic polyether urethane diacrylate, hydroxy-functionalized aliphatic polyester urethane diacrylate, hydroxy-functionalized aromatic polyether urethane diacrylate, hydroxy-functionalized aromatic polyester urethane diacrylate, hydroxy-functionalized polyester diacrylate, hydroxy-functionalized polyether diacrylate, hydroxy-functionalized epoxy diacrylate, hydroxy-functionalized acrylated acrylic diacrylate, hydroxy-functionalized aliphatic polyether urethane polyacrylate, hydroxy-functionalized aliphatic polyester urethane polyacrylate, hydroxy-functionalized aromatic polyether urethane polyacrylate, hydroxy-functionalized aromatic polyester urethane polyacrylate, hydroxy-functionalized polyester polyacrylate, hydroxy-functionalized polyether polyacrylate, hydroxy-functionalized epoxy polyacrylate, hydroxy-functionalized acrylated acrylate or mixtures thereof.

As melamine resins, in particular, those which can be obtained by reacting melamine with aldehydes and optionally can be partially or completely modified are suitable.

In particular, formaldehyde, acetaldehyde, isobutyraldehyde and glyoxal are suitable as aldehydes.

Melamine formaldehyde resins are preferably reaction products of the reaction of melamine with aldehydes, for example the above-named aldehydes, in particular formaldehyde. The methylol groups obtained are preferably modified by etherification with mono- or polyhydric alcohols.

Further, it is possible for the first protective layer 5 to have precured systems and/or hybrid systems. It is possible in particular for the first protective layer 5 to be selected from UV-curable monomers and/or UV-curable oligomers or mixtures thereof with at least one binder from the group which consists of polyurethanes, polyacrylates, polymethacrylates, polyester resins, polycarbonates, phenolic resins, epoxy resins, polyureas, melamine resins, preferably polymethyl methacrylate (PMMA), polyester, polycarbonate (PC) and mixtures thereof.

It is further possible for the first protective layer to comprise at least one of the above-named polyisocyanates.

In particular, the first protective layer 5 and the at least one receiving layer 4 and/or the first and second coating compositions are in each case an at least physically drying system. The at least one receiving layer 4 and/or the first coating composition is in particular an at least physically drying layer which is preferably formulated from thermoplastics. It is possible in particular for the first protective layer 5 and/or the second coating composition to differ from the at least one receiving layer 4 and/or the first coating composition in that the first protective layer 5 and/or the second coating composition is chemically crosslinkable and/or is curable by means of UV radiation. The first protective layer 5 preferably differs from the at least one receiving layer 4 in that the first protective layer 5 at least one chemically crosslinkable polymer, in particular consists of isocyanate-group-containing polymers or melamine-containing polymers or hydroxyl-group-containing polymers or mixtures thereof, wherein the at least one receiving layer 4 is based on a thermoplastic polymer and/or a thermoplastic resin.

Preferably, it is thus possible that in particular the at least one receiving layer 4 and/or the first coating composition is preferably not chemically crosslinkable or crosslinked and/or is not crosslinkable or crosslinked by means of UV radiation. In particular, the curing of the first coating composition and/or the at least one receiving layer 4 is effected by means of normal drying, preferably merely by means of normal drying, thus preferably merely by release of solvents contained in the first coating composition and/or the at least one receiving layer 4. The at least one receiving layer 4 is thus preferably a merely physically drying or dried system in the transfer film and/or the component. The first protective layer 5 and/or the second coating composition is preferably a physically drying system, which is preferably still chemically crosslinkable in the transfer film 1 and/or is preferably still chemically crosslinkable or chemically crosslinked in the component 10.

Further, the at least one receiving layer preferably 4 has a roughness Ra in the range of from 1 nm to 250 nm, preferably in the range of from 5 nm to 100 nm, in particular measured when the carrier ply 3 has been detached from the transfer ply 2 and/or when the first protective layer 5 and/or the at least one receiving layer 4 has not yet been completely cured. As a result of this, in particular, the adhesion of the at least one coating to the at least one receiving layer is improved and the durability of the protective layer composite 21 with the at least one coating is improved.

The first protective layer 5 has for example a layer thickness of 3 μm. It is expedient in particular that the first protective layer 5 has a layer thickness in a range of from 1 μm to 15 μm, preferably in a range of from 2 μm to 8 μm, preferably in a range of from 2 μm to 5 μm.

The at least one receiving layer 4 here has for example a layer thickness of 0.5 μm. It is expedient in particular that the at least one receiving layer 4 has a layer thickness in a range of from 0.01 μm to 1 μm, preferably in a range of from 0.05 μm to 0.5 μm.

With such a relatively small layer thickness of the at least one receiving layer 4, it is possible for example for in particular a necessary durability of the protective layer composite 21 by means of the first protective layer 5 to be retained and for the coatability of the protective layer composite 21 to be improved.

In particular, the transfer ply 2 is detachable from the carrier ply 3. Further, it is expedient that the carrier ply 3 is arranged on the protective layer composite 21, in particular the at least one receiving layer 4 and/or the first protective layer 5, with an adhesive force in a range of from 2 cN to 50 cN, preferably in a range of from 5 cN to 35 cN.

As FIG. 1B shows, the carrier ply 3 preferably has at least one detachment layer 32, which is arranged between the carrier layer 31 and the protective layer composite 21 and preferably comprises or consists of at least one wax.

The detachment layer 32 preferably comprises or consists of polyethylene wax and in particular has a melting temperature in a range of from 80° C. to 100° C. The transfer ply 2, in particular the at least one receiving layer 4, preferably has been or is arranged at least in regions on the side of the detachment layer 32 which faces away from the at least one carrier layer 31. The detachment layer 32 preferably has a layer thickness in a range of from 0.1 nm to 50 nm.

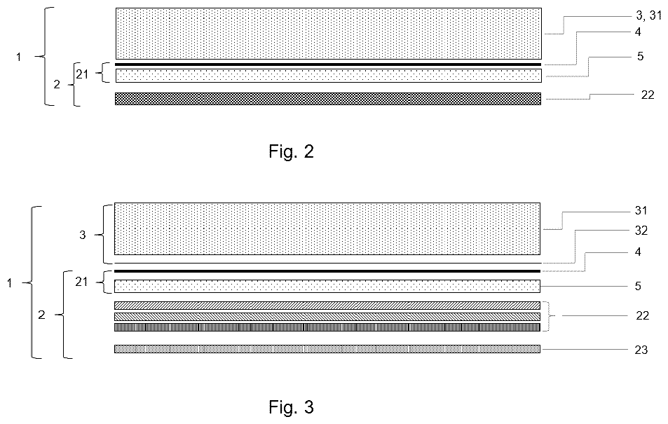

FIG. 2 shows the transfer film 1 shown in FIG. 1A, except that the transfer ply 2 has a decorative layer 22 on the side of the protective layer composite 21 facing away from the carrier ply 3. Here, it is also possible in particular for a detachment layer 32 as shown in FIG. 1B to be present. The decorative layer 22 preferably contains at least one decorative element. It is also possible for example for the transfer ply 2 to have, instead of the one decorative layer 22, several decorative layers, which have at least one decorative element. As FIG. 2 further schematically shows, it is also possible for the layers shown to overlap over the whole surface.

The decorative layer 22, or in particular the several decorative layers, is preferably selected, preferably in each case independently of one another, from the group which consists of transparent and/or colored varnish layers, in particular comprising one or more dyes and/or pigments, replication layers with molded optically active surface structure, reflective layers, in particular opaque reflective layers, transparent reflective layers, metallic reflective layers or dielectric reflective layers, optically variable layers, optically active layers, interference multilayer systems, volume hologram layers, liquid-crystal layers, in particular cholesteric liquid-crystal layers, electrically conductive layers, antenna layers, electrode layers, magnetic layers, magnetic storage layers, barrier layers and combinations thereof.

Further, it is possible for an adhesion-promoter layer, not represented in more detail, to be arranged between the protective layer composite 21, in particular the first protective layer 5, and the at least one decorative element. The adhesion-promoter layer preferably comprises or consists of at least one acrylic resin and preferably has a layer thickness of at most 10 μm, in particular in a range of from 0.1 μm to 10 μm.

Further, it is possible for the transfer ply 2 to have one or more functional layers containing at least one functional element on the side of the protective layer composite 21 facing away from the carrier ply 3. The functional element can thus be present in particular as an alternative or in addition to the at least one decorative element. Thus, it is also possible for one or more of the one or more functional layers to be arranged overlapping and/or neighboring one or more of the one or more decorative layers 22. It also possible for one or more of the one or more functional layers to be arranged between one or more of the one or more decorative layers 22 or on a side of the one or more decorative layers 22 facing towards and/or facing away from the protective layer composite 21.

A functional element is preferably selected from the group which consists of one or more electronic elements, in particular one or more conductive tracks, contact elements, LEDs, sensors, in particular touch sensors, temperature sensors, pressure sensors, antennas, in particular RFID elements, memories, processors, capacitors, resistors, microfluidic elements and combinations thereof.

FIG. 3 shows the transfer film 1 shown in FIG. 2, except that the carrier ply 3 further has the detachment layer 32, as is shown for example in FIG. 1B, and that the transfer film 1 has several decorative layers 22 as well as the optional varnish layer 23 arranged on the surface of the transfer ply 2 facing away from the carrier ply 3.

It is herewith possible for the transfer ply 2 to have at least one varnish layer 23, which forms a surface of the transfer ply 2 facing away from the carrier ply 3. The at least one varnish layer 23 preferably has a layer thickness of at most 10 μm, in particular in a range of from 0.5 μm to 10 μm. Preferably, the at least one varnish layer comprises or consists of at least one adhesive, which is selected from the group which consists of physically curing adhesives, chemically curing adhesives, pressure-sensitive adhesives or mixtures thereof. It is possible for the at least one varnish layer 23 to be a primer layer, for a primer layer to be arranged in place of the at least one varnish layer 23 or for a primer layer to be arranged on the side of the at least one varnish layer 23 facing away from the protective layer composite 21, in particular wherein the primer layer comprises or consists of PVC copolymers and PMMA (PVC=polyvinyl chloride, PMMA=polymethyl methacrylate).

Further, it is possible for the at least one decorative element to be arranged in one or more decorative layers of the decorative layers 22, which comprise, in each case independently of one another, a UV-crosslinked varnish or a thermoplastically deformable layer and which are, in each case independently of one another, unpigmented or pigmented or dyed. It is also conceivable that in each case a decorative element is arranged in each layer of the decorative layers 22.

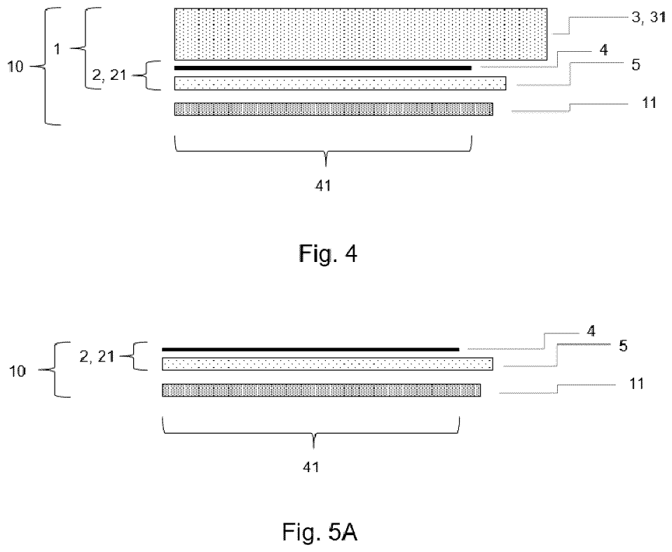

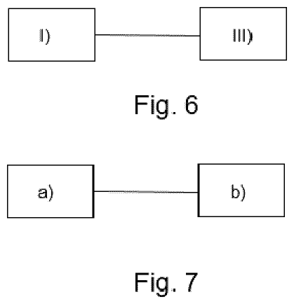

FIG. 4 shows, in an exploded drawing, a component 10, in particular a casing component for motor vehicles or domestic appliances. The component 10 comprises a base body 11 and at least one transfer ply 2 of a transfer film 1 arranged against at least one surface of the base body 11 at least in regions. With respect to the design of the transfer film 1, reference is made in particular to the above statements. The transfer film 1 is for example designed as is described in relation to FIG. 1A, 1B, 2, 3 or 4 and/or produced as is described in relation to FIG. 6. The transfer ply 2 comprises the protective layer composite 21, which has a first protective layer 5 and at least one receiving layer 4. The at least one receiving layer 4 is arranged on the first protective layer 5 in the coatable region 41 and is arranged on a side of the transfer ply 2 facing away from the base body 11.

It is possible in particular for the base body 11 to be selected from the group which consists of paper, plastic, wood, composite, glass, metal and combinations thereof. For example, the base body 11 is a plastic injection-molding material which in particular comprises or consists of PMMA.

As FIG. 4 schematically shows, it is possible in particular for the component 10 also to comprise at least one transfer film 1 which is arranged against at least one surface of the base body 11 at least in regions and which in particular also has the carrier ply 3 of the transfer film 1. It is possible that the protective layer composite 21 is not yet completely cured and/or is at least partially curable. Thus, it is possible that the component 10, preferably as an intermediate product, is still protected by the carrier ply 3 and that the carrier ply 3 can only be detached shortly before an application of the at least one coating or preferably at least only after the joining of the transfer ply 2 to the base body 11. In particular due to a curing of the at least one coating and the protective layer composite 21 after the application of the at least one coating, the protective function is then taken on by the protective layer composite 21 and the at least one coating.

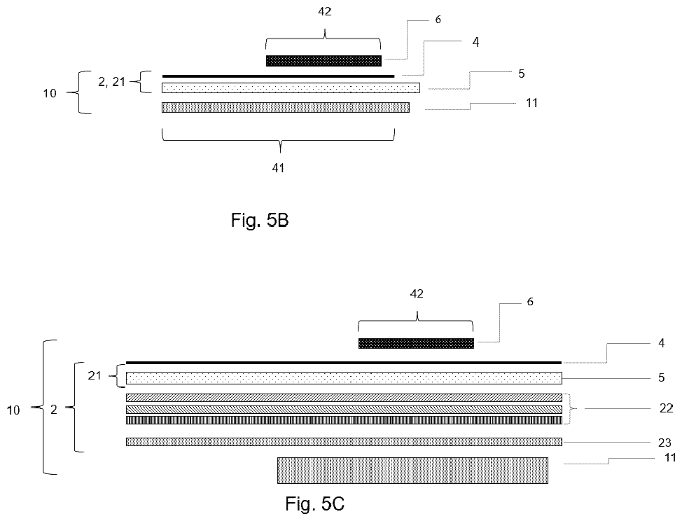

FIG. 5A shows the component 10 shown in FIG. 4, except that the carrier ply 3 of the transfer film 1 is not present. It is possible here for the carrier ply 3 shown in particular in FIG. 4 to be detached. The component 10 thus preferably has at least the transfer ply 2 of the transfer film 1, as is shown for example in one of FIG. 1A, 1B, 2 or 3.

It is thus possible for the component 10 to comprise the above-named one or more decorative layers 22 containing at least one decorative element and/or the above-named one or more functional layers containing at least one functional element. Further, it is conceivable that the component 10 comprises further decorative elements or functional elements, which are introduced for example before, during or after a joining of the base body 11 to at least one transfer ply 2. The at least one functional element is preferably arranged in one or more functional layers, which comprise, in each case independently of one another, a UV-crosslinked varnish or a thermoplastically deformable layer and which are, in each case independently of one another, unpigmented or pigmented or dyed.

In particular, it is possible here for the coatable region 41 to form an outside of the component 10 at least in regions. FIG. 5A thus shows in particular the component 10 in a state in which the coatable region 41 is then coated.

FIG. 5B shows in particular the component 10 shown in FIG. 5A, except that the at least one coating 6 is applied in a coated region 42 of the coatable region 41 at least in regions, here in particular over the whole surface, in particular wherein the coated region 42 overlaps the coatable region 41 in regions. It is possible here for the coated region 42 to be patterned. It is also conceivable that the coated region 41 overlaps the coatable region 42 over the whole surface.

It is possible here that the at least one coating 6 and/or the protective layer composite 21 is not yet completely cured and/or is curable. It is also possible that the at least one coating 6 and/or the protective layer composite 21, in particular the at least one receiving layer 4 and/or the first protective layer 5, is completely cured. It is thus possible for the component 10 to be protected by means of the protective layer composite 21 and the at least one coating 6 and for example to be individualized by means of the at least one coating 6.

The at least one coating 6 shown in FIG. 5B is in particular a printed layer of a UV printing ink or a UV ink.

It is possible in particular for the at least one coating 6 to comprise one or more of the following layers: one or more printed layers, one or more further protective layers, one or more further transfer plies and/or one or more further transfer films. In particular if the at least one coating 6 comprises one or more further protective layers, the one or more further protective layers are preferably arranged only in regions in the coatable region 41, in particular with the result that the protective layer composite in the coatable region 41 further forms an outermost surface of the component 10 with a protective function. In particular if the at least one coating 6 comprises one or more printed layers, these preferably form an outermost surface of the component 10 with a protective function at least in regions.

One or more printed layers, preferably in each case independently of one another, in particular comprise or consist of an inkjet printing ink and/or a pad printing ink and/or a screen printing ink and/or preferably comprise or consist of a UV printing ink, a UV ink, a solvent printing ink and/or an aqueous printing ink. UV printing inks are preferably used for the pad printing and/or screen printing. UV inks are preferably used for inkjet printing. In particular, it is possible for the viscosity, preferably the dynamic viscosity, of UV printing inks to be higher than the viscosity, preferably the dynamic viscosity, of UV inks. A UV printing ink and/or a UV ink is in particular curable by means of UV irradiation and preferably comprises corresponding photoinitiators.

In particular, one or more layers of the one or more printed layers comprise at least one UV printing ink and/or at least one UV ink, which preferably comprises or consists of monomers with at least one ethylenically unsaturated double bond or oligomers with at least one ethylenically unsaturated double bond or mixtures thereof.

It is further possible for the at least one UV printing ink and/or the at least one UV ink to have one or more of the following constituents:
2-(2-vinyloxyethoxy)ethyl acrylate, in particular with a concentration in a range of from at least 50 wt.-% to less than 100 wt.-%;
oxybis(methyl-2,1-ethanediyl) diacrylate, in particular with a concentration in a range of from at least 10 wt.-% to less than 20 wt.-%;
diphenyl(2,4,6-trimethylbenzoyl)phosphine oxide, in particular with a concentration in a range of from at least 3 wt.˜% to less than 5 wt.-%;
phenylbis(2,4,6-trimethylbenzoyl)phosphine oxide, in particular with a concentration in a range of from at least 1 wt.-% to less than 5 wt.-%;
2,6-bis(1,1-dimethylethyl)-4-methylphenol, in particular with a concentration in a range of from at least 0.1 wt.-% to less than 0.25 wt.-%, preferably in each case relative to the total weight of the at least one UV printing ink and/or the at least one UV ink.

It is further possible for at least one of the one or more further protective layers to be a protective varnish layer.

Preferably, one or more layers of the one or more printed layers have a layer thickness of at most 5 mm, in particular in a range of from 0.2 mm to 5 mm. It is also possible for one or more layers of the one or more further protective layers to have a layer thickness of at most 5 mm, in particular in a range of from 0.2 mm to 5 mm. It is possible in particular for the at least one coating 6 to have such a layer thickness.

The tests described above are preferably carried out in a test region of the component 10. The at least one coating 6 and/or the protective layer composite 21 is preferably completely cured, wherein corresponding test results are preferably achieved in particular in the completely cured state of the at least one coating 6 and of the protective layer composite 21. The test region preferably comprises a surface of the component 10 facing away from the base body 11, at least in the coatable region 41, in particular with the coated region 42 with the at least one coating 6 and preferably with the coatable region 41 outside the coated region 42. Further, it is possible for the test region preferably also to have a surface of the first protective layer 5.

It is also possible for a test region to comprise the surface of the coatable region 41 of the transfer ply 2 of the transfer film 1 on the side of the receiving layer 4 with a test coating, wherein to carry out the tests the transfer film 1 is applied to a base, the carrier ply 3 is peeled off the transfer ply 2, a test coating is applied to the at least one receiving layer 4 in the test region, wherein the test coating is designed corresponding to the at least one coating of the component 10, and the test coating and the protective layer composite 21 are completely cured.

The at least one coating 6 and the protective layer composite 21 advantageously make a mechanically and chemically resistant product possible which has a particularly well adhering coating and can in particular be coated still further with this coating in an almost finished state. As a result of this, in addition to the durability, for example the flexibility in the manufacture and the individualizability of the component are preferably increased. In particular the at least one coating 6 thus has a double function, for example as an information carrier for an observer and as a protective layer. With respect to advantageous test results, reference is made in particular to the above statements.

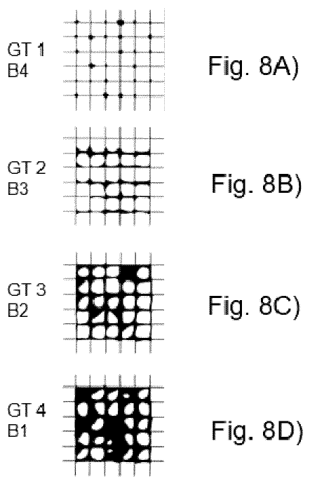

The criteria for a classification of the corresponding characteristic values of the cross-cut test are preferably to be found in the table below, in particular wherein possible surfaces of the test region are shown schematically with FIG. 8A, FIG. 8B, FIG. 8C and FIG. 8D:

| | | ISO | ASTM |
|---|---|---|---|
| | Surface of | charac- | charac- |
| | the test | teristic | teristic |
| Description | region | value | value |
| The edges of the cuts are | — | GT 0 | 5B |
| completely smooth, no section of | | | |
| the coating has flaked. | | | |
| Small flakes of the coating have | FIG. 8a) | GT 1 | 4B |
| detached at the intersections of | | | |
| the grid lines; flaked area | | | |
| approximately 5% of the | | | |
| sections. | | | |
| The coating has flaked along the | FIG. 8b) | GT 2 | 3B |
| edges of the cuts and/or at the | | | |
| intersections of the grid lines; | | | |
| flaked area approximately 15% | | | |
| of the sections. | | | |
| The coating has flaked partially | FIG. 8c) | GT 3 | 2B |
| or completely in broad strips | | | |
| along the edges of the cuts | | | |
| and/or the coating has flaked | | | |
| completely or partially on | | | |
| individual sections; flaked area | | | |
| approximately 35% of the | | | |
| sections. | | | |
| The coating has flaked in broad | FIG. 8d) | GT 4 | 1B |
| strips along the edges of the | | | |
| cuts and/or completely or | | | |
| partially on individual sections; | | | |
| flaked area approximately 65% | | | |
| of the sections. | | | |
| Flaked area more than 65% of | — | GT 5 | 0B |
| the sections. | | | |

In a range of from GT 0 to GT 1 and/or from 5B to 4B thus preferably means that an area of at most 5% and/or between 0% and 5% has flaked.

FIG. 5C schematically shows, in an exploded drawing, a component 10, in particular as described in FIG. 5B, with a transfer ply 2 preferably as described in FIG. 3.

A component 10 in particular as described in relation to FIG. 5B and/or FIG. 5C is used for example as a vehicle part, in particular a vehicle interior trim and/or vehicle exterior trim, housing part or external part of in particular white goods and/or domestic appliances and/or as a display window for electronic devices.

FIGS. 1A, 1B, 2, 3, 4, 5A, 5B and 5C are, in particular, exploded drawings and in each case show cross sections of the transfer film 1 and/or the component 10. It is possible here for the layers of the transfer film 1 and/or of the component 10 as well as the base body 11 and in particular the at least one coating 6 to have surfaces which are depicted neighboring and directly adjoin one another at least in regions in the component 10 or the transfer film 1 or preferably form a transition region with a transition layer and/or a mixed layer between the layers with the surfaces depicted neighboring. Further, it is possible for example for the surfaces of the transfer film 1 and/or of the component 10 as well as of the base body 11 and in particular of the at least one coating 6 to be curved or bent at least in regions. These surfaces span a plane in particular in a top view of the exploded drawing in cross section.

FIG. 6 shows a method for producing a transfer film 1, in particular as is shown in one of FIGS. 1A, 1B, 2, 3 and/or 4. In the method the following steps are carried out, in particular in the specified sequence:
I) providing at least one carrier layer 31 of a carrier ply 3;
III) applying a transfer ply 2 to the carrier ply 3, wherein the transfer ply 2 has a protective layer composite 21 comprising a first protective layer 5 and at least one receiving layer 4 for coating the transfer ply 2 in a coatable region 41 with at least one coating 6, wherein the at least one receiving layer 4 is arranged on the first protective layer 5 and wherein the at least one receiving layer 4 is arranged against a first surface of the transfer ply 2 facing towards the carrier ply 3.

It is possible in particular for further steps to be carried out between step I) and step III) and/or for carrying out step III).

In particular, in step III) the at least one receiving layer 4 is applied to the carrier ply 3 in the coatable region 41 and the first protective layer 5 is applied to the at least one receiving layer 4 at least in the coatable region 41 and to the carrier ply 3 optionally outside the coatable region 41.

The first protective layer 5 preferably starts to dissolve the at least one receiving layer 4, in particular in such a way that a mixed layer forms between the at least one receiving layer 4 and the first protective layer 5 or from the at least one receiving layer 4 and the first protective layer 5. The at least one receiving layer 4 and/or the mixed layer thus preferably forms a surface which is more easily dissolved by means of the at least one coating 6, preferably in the form of a UV printing ink. It is hereby possible for the adhesion to the at least one coating 6 to be improved.

Further, it is possible for the first protective layer 5 and/or the at least one receiving layer 4 to be applied to the carrier ply 3 in step III) by means of printing, in particular by means of gravure printing and/or flexographic printing and/or inkjet printing.

It is also possible for example for the following step to be carried out preferably before step III):
II) applying a detachment layer 32 to the carrier layer 31 of the carrier ply 3 in such a way that the detachment layer 32 preferably forms a surface of the carrier ply 3 to which the protective layer composite 21 is applied at least in regions in step III). The application of the detachment layer 32 to the carrier layer 31 of the carrier ply 3 in step II) is preferably carried out by means of gravure printing and/or flexographic printing and/or inkjet printing.

The application of the at least one receiving layer 4 in step III) preferably comprises the following step:
IIIa) applying at least one, preferably flowable, first coating composition to at least partial regions of a surface of a first side of the carrier ply 3, wherein the at least one first coating composition has at least one solvent and at least one water-dispersible polymer, which is selected from the group which consists of polyurethanes, polyacrylates, polymethacrylates, polyesters, copolymers thereof and mixtures thereof
and at least partially curing the at least one first coating composition, to obtain at least one receiving layer 4. The at least partial curing in step IIIa) is preferably a physical drying. The first coating composition is thus in particular physically drying. It is possible here for in particular no curing which is carried out by chemical crosslinking and/or by means of UV irradiation to be carried out.

The first coating composition preferably comprises at least one water-dispersible polymer, which is selected from the group which consists of aqueous polyurethane dispersions, aqueous dispersion of polyurethane/polyacrylate copolymers, aqueous polyacrylate and/or polymethacrylate dispersions, aqueous polyester dispersions and mixtures thereof. It is further possible for the first coating composition to comprise at least one polyurethane-containing polymer, which is preferably selected from the group which consists of polyurethanes, polyurethane/poly(meth)acrylate copolymers and mixtures thereof.

The first coating composition preferably comprises at least one solvent, which consists of water, organic solvents, preferably aliphatic alcohol, such as ethanol, isopropanol and butanol or mixtures thereof.

The dynamic viscosity of the first coating composition preferably has been or is chosen depending on the printing method, for example in the case of a gravure printing method depending on the speed and gridding of the gravure printing cylinder. The first coating composition preferably has a dynamic viscosity in a range of from 10 mPas to 1000 mPas, preferably in a range of from 50 mPas to 500 mPas, in particular measured in a state immediately before step IIIa).

For example, water has a dynamic viscosity of 1 mPas. A very thin first coating composition preferably has a dynamic viscosity of 50 mPas. A thick first coating composition has in particular a dynamic viscosity of 500 mPas.

It is further expedient that the application of the first protective layer 5 in step III) comprises the following step:
IIIb) applying at least one, preferably flowable, second coating composition to at least partial regions of a surface of the side of the at least one receiving layer 4 facing away from the carrier ply 3, wherein the at least one second coating composition comprises at least one UV-crosslinkable and/or chemically crosslinkable polymer, and at least partially curing the at least one second coating composition, to obtain at least one first protective layer 5.

It is also possible for the second coating composition to be physically drying. The at least partial curing in step IIIb) is preferably a physical drying. It is in particular conceivable that the first protective layer starts to dissolve the at least one receiving layer before the partial curing, as a result of which the mixed layer preferably forms. In particular, at least the mixed layer is preferably at least partially cured by physical drying.

It is expedient that the at least one second coating composition has at least one UV-crosslinkable polymer and preferably furthermore at least one chemically crosslinkable polymer, which is further preferably selected from the group which consists of isocyanate-group-containing polymers, melamine-containing polymers, hydroxyl-group-containing polymers and mixtures thereof. It is possible here for the at least one second coating composition to have at least one polymer and/or copolymer with at least one isocyanate group and at least one polymer and/or copolymer with at least one hydroxyl group

and/or at least one melamine resin and at least one polymer and/or copolymer with at least one hydroxyl group. In particular, a chemical crosslinking is herewith provided by the reaction of isocyanate groups with hydroxyl groups and/or by the reaction of melamine resins with hydroxyl groups.

In particular, the at least one UV-crosslinkable polymer furthermore has at least one chemically crosslinkable functional group, which is preferably selected in each case independently of one another from hydroxyl group, isocyanate group, melamine group, epoxide group.

It is also possible for the at least one UV-crosslinkable polymer to have at least one hydroxyl group.

With respect to suitable hydroxyl-group-containing polymers, melamine resins, aldehydes, melamine formaldehyde resins, precured and/or hybrid systems as well as polyisocyanates, reference is made in particular to the above statements.

The at least one receiving layer 4 preferably has one or more of the following constituents, in particular with a concentration in percent by weight, preferably based on a liquid state of the at least one receiving layer 4, in the range specified in each case:

| Constituent | Concentration in percent by weight |
|---|---|
| Deionized water | 25-35 |
| Isopropanol | 55-65 |
| Aqueous polyurethane dispersion | 5-15 |
| Cellulose derivative | 5-10 |
| Carnauba wax dispersion | 10-15 |
| Additives | 1-3 |
| Ammonia 25%, preferably a 25% | 0.1-0.5 |
| ammonia solution, preferably in | |
| water and/or isopropanol | |

By the liquid state of the at least one receiving layer 4 is meant in particular that solvents have not yet leaked out of the at least one receiving layer 4. In particular, it also means a state of the at least one receiving layer 4 immediately before or after the application of the at least one receiving layer 4 to the carrier ply 3.

The first protective layer 5, in particular in the form of a protective varnish layer, preferably has one or more of the following constituents, in particular with a concentration in percent by weight, preferably based on a liquid state of the first protective layer 5, in the range specified in each case:

| | Concentration in |
|---|---|
| Constituent | percent by weight |
| Melamine formaldehyde resin | 0.1-1.5 |
| Catalyst | 0.1-1.5 |
| Ethanol | 15-20 |
| Diacetone alcohol | 15-20 |
| 60% solution of a hydroxyl-containing | 20-30 |
| polyacrylic acrylate in an organic solvent | |
| Polyacrylic acrylate | 4-6 |
| Amorphous silica | 2-5 |
| Cyclohexanone | 10-20 |
| Methyl ethyl ketone | 10-12 |
| Photoinitiator | 0.1-1 |

By the liquid state of the first protective layer 5 is meant in particular that solvents have not yet leaked out of the first protective layer 5. In particular, it also means a state of the first protective layer 5 immediately before or after the application of the first protective layer 5 to the at least one receiving layer 4 and/or the carrier ply 3.

FIG. 7 schematically shows a method for producing a component 10, as shown for example in one of FIGS. 4, 5A and 5B, using a transfer film 1, as shown for example in one of FIG. 1A, 1B, 2 or 3 and/or produced for example as described in FIG. 6. The method for producing the component 10 comprises the following steps, in particular in the specified sequence:
a) providing a transfer film 1 which comprises a carrier ply 3 with at least one carrier layer 31 and a transfer ply 2 arranged on the carrier ply 3, wherein the transfer ply 2 has a protective layer composite 21 comprising a first protective layer 5 and at least one receiving layer 4 for coating the transfer ply 2 in a coatable region 41 with at least one coating 6, wherein the at least one receiving layer 4 is arranged on the first protective layer 5 and wherein the at least one receiving layer 4 is arranged against a first surface of the transfer ply 2 facing towards the carrier ply 3;
b) joining a base body 11 to at least one surface of the transfer ply 2 facing away from the carrier ply 3;
c) detaching the carrier ply 3 from the transfer ply 2 joined to the base body 11;
d) applying at least one coating 6 to a surface of the transfer ply 2 opposite the base body 11, wherein the at least one coating 6 is applied in a coated region 42 which is arranged in the coatable region 41 at least in regions or over the whole surface.

The at least one coating 6 is preferably applied patterned.

It is possible in particular for further steps to be carried out between steps a), b), c) and/or d) and/or for carrying them out. For example, it is possible for a transporting to take place between the steps. It is thus possible for the steps to be carried out “inline” or “offline”.

It is also possible for example for the following steps to be carried out, in particular in the specified sequence, for carrying out step b) for joining the base body 11 to the transfer ply 2:
b1) arranging the transfer film (1) in an injection mold;
b2) back-injection molding the transfer film 1 arranged in the injection mold with a plastic injection-molding material, in particular wherein a joining of the plastic injection-molding material to the transfer ply 2 takes place through the back-injection molding and/or the base body 11 is formed by the plastic injection-molding material.

During the joining of the base body 11 to the transfer ply 2 in step b), in particular in step b2), the base body 11 with at least one surface of the transfer ply 2 of the transfer film 1 facing away from the carrier ply 3 is preferably covered with the plastic injection-molding material at least in regions, wherein the transfer film 1 is arranged in the injection mold and the injection mold is filled with at least the plastic injection-molding material. The plastic injection-molding material preferably comprises a thermoplastic, a thermoset or a mixture thereof. Further, it is possible for the injection mold to be formed by two mold halves, in particular which are opened before step b1) and are closed before step b2), preferably wherein the injection mold is formed.

It is herewith possible in particular for the component 10 to be a rigid body. It is also possible for the surface of the component 10, in particular with the protective layer composite 21 and the at least one coating 6, to be curved and/or bent. The injection mold expediently has the shape of the surface of the component 10 and/or predefines it.

It is also conceivable that the joining of the base body 11 to at least one surface of the transfer ply 2 of the transfer film 1 facing away from the carrier ply 3 is effected in step b) by adhesive bonding, hot stamping, lamination or combinations thereof on at least one surface of the base body 11 which is selected from the group which of paper, plastic, wood, composite, glass, metal and combinations thereof.

It is possible for there to be a spatial separation between the joining of the base body 11 to the at least one transfer ply in step b) and the detachment of the carrier ply 3 in step c). Here, it is possible for the component 10 to be stored temporarily and/or transported. In particular at another production location, it is then possible to individualize the component 10 by means of the application of the at least one coating.

Preferably, it is further possible for the following step to be carried out after step b), and in particular before step c), after step c), and in particular before step d), and/or after step d):
e) removing the base body 11 with the transfer ply 2 from the injection mold.

It is possible for example for step e) to be carried out before step c). It is thus possible in particular for the at least one coating, for example for individualizing the component, to be carried out after the detachment of the carrier ply 3 at another location. The component is thus protected by the carrier ply 3 for example during a transporting to the other location.

Further, it is possible for the carrier ply to be peeled off immediately after the joining of the transfer ply 2 to the base body 11 in step b) and/or before the removal of the base body 11 with the transfer ply 2 from the injection mold in step e). The carrier ply 3 is thus preferably peeled off still in an injection-molding tool with the injection mold, in particular wherein the method is an IMD method.

The method preferably further comprises the following step:
f) completely curing the protective layer composite 21, in particular the at least one receiving layer 4 and/or the first protective layer 5, and/or the at least one coating 6.

Such a method makes it possible in particular for the component 10 produced to achieve the above-named advantageous test results after the complete curing.

In step f) all curable constituents of the component, in particular the protective layer composite 21 and the at least one coating 6, are preferably completely cured. Step f) is preferably carried out after step d), and in particular before or after step e).

It is also conceivable that the curing of the first protective layer 5 is effected by means of UV irradiation in a varnishing machine and/or printing device, in particular after the application of the at least one coating 6 in step d). It is possible in particular for the curing to be effected in several sub-steps, for example for a precuring and/or a complete curing of the UV printing ink and/or the UV ink to be carried out in the varnishing machine and/or the printing device, wherein it is possible for the protective layer composite to be cured as well at least in regions. Further, it is possible for a complete curing of the entire component 10 then to be carried out, in particular by irradiating the component 10 or at least all UV-curable regions of the component with UV irradiation over the whole surface.

The component 10 is advantageously particularly durable after step f) because of the durability of the at least one coating 6 and the protective layer composite 21. It is thus possible for the component 10 to be protected by the carrier ply 3 and/or protected by the protective layer composite 21 and/or the at least one coating 6. For example, a particularly reliable and flexible method is also guaranteed herewith.

In particular, it is possible for the complete curing of the at least one receiving layer 4, the first protective layer 5 and/or the at least one coating 6 to be carried out in step f) by means of high-energy electromagnetic radiation, in particular UV irradiation, and/or by means of high-energy particle radiation, in particular electron beam radiation.

The irradiation is preferably carried out by means of high-energy electromagnetic radiation and/or high-energy particle radiation. The electromagnetic radiation is preferably UV radiation, in particular from a wavelength range of from 100 nm to 390 nm, preferably 200 nm to 380 nm, particularly preferably 200 nm to 300 nm. The particle radiation is preferably electron beam radiation.

For the complete curing in step f) one or more irradiation units are preferably used, which are preferably arranged behind the printing device. Step f) is carried out correspondingly in particular after step d). For the complete curing in step f) the component, in particular the at least one coating and/or the protective layer composite, preferably the first protective layer and/or the at least one receiving layer, is irradiated with an irradiance in a range of from 500 mW/cm² to 700 mW/cm². The UV dose preferably lies in a range of from 2000 mJ/cm² to 3500 mJ/cm².

Further, it is conceivable that the complete curing of the at least one receiving layer 4, the first protective layer 5 and/or the at least one coating 6 is carried out in step f) alternatively or additionally by means of curing, preferably at a temperature in a range of from 25° C. to 180° C., of the at least one receiving layer 4, the first protective layer 5 and/or the at least one coating 6.

In step d) the at least one coating 6 is preferably applied in the form of one or more printed layers, in particular by means of digital printing, preferably by means of inkjet printing and/or pad printing and/or screen printing.

The digital printing is for example a UV digital printing. Here, in particular, a printhead from Kyocera, preferably of the KJ4A-RH type, is used. The resolution of the printhead is in particular 1200×600 dpi in the RGB color space and/or 600×600 dpi in the CMYK color space. The printhead is in particular moved at a maximum speed of 600 mm/s.

It is expedient that in the method for producing the component 10, in particular in step d), one or more layers of the one or more printed layers preferably comprise at least one UV printing ink and/or at least one UV ink, which preferably comprises or consists of monomers, in particular with at least one ethylenically unsaturated double bond, or oligomers, in particular with at least one ethylenically unsaturated double bond, or mixtures thereof.

Further, it is expedient that in the method for producing the component, in particular in step d), the at least one UV printing ink and/or the at least one UV ink has one or more of the following constituents, wherein the concentration is preferably specified in percent by weight:
2-(2-vinyloxyethoxy)ethyl acrylate, in particular with a concentration in a range of from at least 50 wt.-% to less than 100 wt.-%;
oxybis(methyl-2,1-ethanediyl) diacrylate, in particular with a concentration in a range of from at least 10 wt.-% to less than 20 wt.-%;
diphenyl(2,4,6-trimethylbenzoyl)phosphine oxide, in particular with a concentration in a range of from at least 3 wt.-% to less than 5 wt.-%;
phenylbis(2,4,6-trimethylbenzoyl)phosphine oxide, in particular with a concentration in a range of from at least 1 wt.-% to less than 5 wt.-%;
2,6-bis(1,1-dimethylethyl)-4-methylphenol, in particular with a concentration in a range of from at least 0.1 wt.-% to less than 0.25 wt.-%, preferably in each case relative to the total weight of the at least one UV printing ink and/or the at least one UV ink.

It is also possible for the base body 11 with the transfer ply 2 to be placed in a printing device, in particular a digital printer, preferably an inkjet printer, for carrying out step d). It is possible here for the detachment of the carrier ply 3 from the transfer ply 2 joined to the base body 11 to be carried out first in the printing device and/or to be carried out before, in particular immediately before, it is placed in the printing device.

It is further possible for the application of the at least one printed layer and/or the at least one receiving layer 4 to be carried out by means of cold stamping. In step d) the application of one or more layers of the at least one coating 6 in a first region to the at least one receiving layer 4 is preferably carried out and optionally the at least one coating 6 is not applied in a second region of the protective layer composite 21. It is also possible here for a second transfer film with a second transfer ply 2 to be applied to the protective layer composite 21 at least in the first region and optionally in the second region. The second transfer film is then preferably peeled off the protective layer composite 21 with the at least one coating 6, in such a way that the second transfer ply remains on the at least one receiving layer 4 at least in regions in the first region, and is preferably peeled off the at least one receiving layer 4 in the second region, in particular together with at least one carrier layer of the second transfer film. It is possible here for the first region to be completely comprised by the coatable region 41.

It is also possible for only partial regions of the first region to be completely comprised by the coatable region 41, in particular wherein the at least one coating 6 is also applied to the first protective layer 5 at least in regions during the application to the at least one receiving layer 4, wherein the second transfer film 12 is then peeled off the protective layer composite 21 with the at least one coating 6, in such a way that the second transfer ply remains only in the partial regions of the first region which are comprised by the coatable region.

It is further conceivable that the at least one coating 6 is modified and/or structured before and/or during and/or after the application of the at least one coating 6 in step d), preferably by placing particles in/on the at least one receiving layer 4 after step c) and/or by using tool structures during the application in step d) and/or by subsequent lasering, overprinting and/or overstamping of the at least one coating 6.

The transfer ply 2 preferably comprises, on its side facing towards the base body 11, in step a) one or more decorative layers 22 containing at least one decorative element and/or one or more functional layers containing at least one functional element. With respect to the decorative layers, the decorative elements, the functional layers and the functional elements, reference is made to the above statements.

### LIST OF REFERENCE NUMBERS

1 transfer film
10 component
11 base body
2 transfer ply
22 decorative layer(s), functional layer(s)
21 protective layer composite
3 carrier ply
31 carrier layer
4 receiving layer
41 coatable region
42 coated region
5 first protective layer
6 at least one coating
32 detachment layer
23 varnish layer, primer layer
I), III), a), b) steps

1. An in-mold decoration (IMD) method for producing a component using an IMD transfer film, wherein the method comprises the following steps:
a) providing the IMD transfer film which comprises a carrier ply with at least one carrier layer and a transfer ply arranged on the carrier ply, wherein the transfer ply has a protective layer composite comprising a first protective layer and at least one receiving layer for coating the transfer ply in a coatable region with at least one coating, and wherein the at least one receiving layer is arranged on the first protective layer, and wherein the at least one receiving layer is arranged against a first surface of the transfer ply facing towards the carrier ply;
b) arranging the transfer film in an injection mold;
c) back-injection molding the transfer film arranged in the injection mold with a plastic injection-molding material, whereby a base body is formed by the plastic injection-molding material, the base body being joined to at least one surface of the transfer ply facing away from the carrier ply;
d) detaching the carrier ply from the transfer ply joined to the base body;
e) applying at least one coating to a surface of the transfer ply opposite the base body, wherein the at least one coating is applied in a coated region which is arranged in the coatable region at least in regions or over the whole surface, and wherein the at least one coating is applied in the form of one or more printed layers, wherein one or more layers of the one or more printed layers comprise at least one UV printing ink and/or at least one UV ink;
f) completely curing the first protective layer and the at least one coating, wherein the complete curing of the first protective layer and the at least one coating is carried out by means of UV irradiation, wherein the component has the at least one coating as an outermost surface.

2. The IMD method according to claim 1, wherein the component has the at least one coating as an outermost surface in regions and also the first protective layer and/or also the at least one receiving layer as the outermost surface in regions.

3. The IMD method according to claim 1, wherein the complete curing of the at least one receiving layer, the first protective layer or the at least one coating is carried out in step f) by means of electromagnetic radiation, and/or particle radiation, and/or is carried out by means of curing, of the receiving layer, the first protective layer and/or the at least one coating.

4. The IMD method according to claim 1, wherein, in step e), the at least one coating is applied in the form of one or more printed layers by means of digital printing, pad printing and/or screen printing.

5. The IMD method according to claim 1, wherein one or more layers of the one or more printed layers comprise at least one UV printing ink and/or at least one UV ink, which comprises or consists of monomers with at least one ethylenically unsaturated double bond or oligomers with at least one ethylenically unsaturated double bond or mixtures thereof.

6. The IMD method according to claim 5, wherein the at least one UV printing ink and/or the at least one UV ink comprises the following constituents:
2-(2-vinyloxyethoxy)ethyl acrylate;
oxybis(methyl-2,1-ethanediyl) diacrylate;
diphenyl(2,4,6-trimethylbenzoyl)phosphine oxide,;
phenylbis(2,4,6-trimethylbenzoyl)phosphine oxide;
2,6-bis(1,1-dimethylethyl)-4-methylphenol.

7. The IMD method according to claim 1, wherein, in step e), the application of one or more layers of the at least one coating in a first region to the at least one receiving layer is carried out and the at least one coating is not applied in a second region of the protective layer composite.

8. The IMD method according to claim 1, wherein the at least one coating is modified and/or structured before and/or during and/or after the application of the at least one coating in step e).

9. The IMD method according to claim 1, wherein the at least one receiving layer is a merely physically drying system or has been produced with a merely physically drying system.

10. The IMD method according to claim 1, wherein the at least one receiving layer has at least one water-dispersible polymer, which is selected from the group which consists of polyurethanes, polyacrylates, polymethacrylates, polyesters, copolymers thereof and mixtures thereof.

11. The IMD method according to claim 1, wherein the first protective layer is produced on the basis of at least one UV-crosslinkable and/or chemically crosslinkable polymer.

12. The IMD method according to claim 1, wherein the first protective layer has at least one chemically crosslinkable polymer.

13. The IMD method according to claim 1, wherein the first protective layer has at least one chemically crosslinkable polymer combination, which comprises or is a polymer and/or copolymer with at least one isocyanate group and at least one polymer and/or copolymer with at least one hydroxyl group and/or at least one melamine resin and at least one polymer and/or copolymer with at least one hydroxyl group.

14. The IMD method according to claim 1, wherein the first protective layer has at least one UV-crosslinkable polymer and/or the at least one receiving layer has at least one chemically crosslinkable functional group.

15. The IMD method according to claim 1, wherein the first protective layer has at least one UV-crosslinkable polymer having at least one hydroxyl group.

16. The IMD method according to claim 1, wherein the first protective layer has a layer thickness in a range of from 1 μm to 15 μm.

17. The IMD method according to claim 1, wherein the at least one receiving layer has a layer thickness in a range of from 0.01 μm to 1 μm.

18. The IMD method according to claim 1, wherein the transfer ply is detachable from the carrier ply and/or wherein the carrier ply has at least one detachment layer which is arranged between the carrier layer and the protective layer composite.

19. The IMD method according to claim 1, wherein the carrier ply is arranged on the protective layer composite with an adhesive force in a range of from 2 cN to 50 cN.

20. The IMD method according to claim 1, wherein the at least one receiving layer has a roughness Ra in a range of from 1 nm to 250 nm.

21. The IMD method according to claim 1, wherein the transfer ply has one or more decorative layers containing at least one decorative element on the side of the protective layer composite facing away from the carrier ply.

22. The IMD method according to claim 21, wherein an adhesion-promoter layer is arranged between the protective layer composite and the at least one decorative element.

23. The IMD method according to claim 1, according to claim 22, wherein the adhesion-promoter layer comprises or consists of at least one acrylic resin.

24. The IMD method according to claim 22, wherein one or more decorative layers of the one or more decorative layers containing the at least one decorative element are selected from the group which consists of transparent and/or colored varnish layers, replication layers with molded optically active surface structure, reflective layers, optically active layers, interference multilayer systems, volume hologram layers, liquid-crystal layers, electrically conductive layers, antenna layers, electrode layers, magnetic layers, magnetic storage layers, barrier layers and combinations thereof.

25. The IMD method according to claim 1, wherein the transfer ply has one or more functional layers containing at least one functional element on the side of the protective layer composite facing away from the carrier ply.

26. The IMD method according to claim 25, wherein the at least one functional element is selected from the group which consists of one or more electronic elements, contact elements, LEDs, sensors, antennas, processors, capacitors, resistors, microfluidic elements and combinations thereof.

27. The IMD method according to claim 21, wherein the at least one decorative element is arranged in one or more decorative layers and/or at least one functional element is arranged in one or more functional layers, the one or more decorative layers and the one or more functional layers each comprising a UV-crosslinked varnish or a thermoplastically deformable layer and are unpigmented or pigmented or dyed.

28. The IMD method according to claim 1, wherein the transfer ply has at least one varnish layer, which forms a surface of the transfer ply facing away from the carrier ply.

29. The IMD method according to claim 28, wherein the at least one varnish layer comprises or consists of at least one adhesive, which is selected from the group which consists of physically curing adhesives, chemically curing adhesives, pressure-sensitive adhesives or mixtures thereof.
